(19) United States
(12) Patent Application Publication
(10) Pub. No.: US 2004/0252601 A1
(43) Pub. Date: Dec. 16, 2004

(54) Apparatus for detecting a discontinuity in a recording track due to the non-circularity of the recording medium and processing data to overcome discontinuity

(75) Inventors: Shoichi Nagatomo, Tokyo (JP); Yoshiyuki Murata, Tokyo (JP); Akihiro Tsukamoto, Tokyo (JP)

Correspondence Address: FRISHAUF, HOLTZ, GOODMAN & CHICK, P.C., 25th Floor, 767 Third Avenue, New York, NY, 10017-2023, US

(73) Assignee: Casio Computer Co., Ltd., Tokyo (JP)

(21) Appl. No.: 10/891,214

(22) Filed: Jul. 13, 2004

Related U.S. Application Data
(62) Division of application No. 09/823,134, filed on Mar. 30, 2001.

(30) Foreign Application Priority Data
Apr. 4, 2000 (JP) 102488 / 2000
Jun. 26, 2000 (JP) 191338 / 2000

(51) Int. Cl. G11B 5/09

(52) U.S. Cl. 369/47.17; 369/53.31

(57) ABSTRACT

A recording medium controlling apparatus for reading/writing data from/to a recording data area as a recording track formed on a non-circular recording medium while rotating the recording medium includes a detector for detecting a discontinuity in the recording track due to the non-circularity of the recording medium during rotation of the recording medium, and a combiner for combining data present on recording data area portions present before and after the discontinuity in a rotating direction of the recording medium and detected by said detecting means so that these data continue.

### CROSS-REFERENCE TO RELATED APPLICATIONS

This is a divisional of U.S. patent application Ser. No. 09/823,134, filed Mar. 30, 2001, the entire disclosure of which is incorporated herein by reference.

This application is based upon and claims the benefit of priority from the prior Japanese Patent Applications No. 2000-102488, filed Apr. 4, 2000 and No. 2000-191338 , filed Jun. 26, 2000, the entire contents of each of which are incorporated herein by reference.

### BACKGROUND OF THE INVENTION

The present invention relates to optically readable non-circular recording mediums, and methods and apparatus for reading data from the non-circular recording mediums.

Conventionally, CD-ROMS (Compact Disc Read Only Memories) are widely used as recording mediums for computers. The CD-ROMS are inexpensive and ensure a large storage capacity, advantageously.

Recently, CDS-R (Compact Discs Recordable) have been put to practical use additionally writable recording mediums to which the user can record data additionally. Data can be written only once to those CDS-R. After recording, the data recorded on each CD-R can be read as in a general CD in a CD drive device.

However, the CD-ROMS and CDS-R each take the forms of a disc having a diameter of 12 cm conforming to the CD the standards. They have a size and a shape unsuitable for portability.

When the CD-ROM or CD-R is bent or damaged, data recorded thereon cannot be read out as the case may be. Thus, in many cases they are received within protective cases when they are carried. However, a case which receives the disc having a diameter of 12 cm is too large to be carried conveniently.

It is therefor an object of the present invention to provide a recording medium excellent in portability, highly convenient, and large in recording capacity.

Another object of the present invention is to provide an apparatus capable of combining data read from a non-circular optical recording medium such as a CD card so as to provide continuous data.

A further object of the present invention is to provide an apparatus capable of reading/writing data from/to a non-circular optical recording medium that includes a CD card while determining the shape of the optical recording medium or its data recording tracks.

### SUMMARY OF THE INVENTION

In order to achieve the above objects, the first invention provides a non-circular recording medium on which a recording track is formed, the recording track comprising an optically readable or writable recording area, wherein: the recording track comprises a discontinuity where no data is writable or readable. The recording medium may have a form such as a triangle, square, polygon, ellipse or star. The recording track may comprise a read only area where data is beforehand recorded and an additionally writing area where data is additionally writable. The recording track may comprise either a plurality of concentric tracks or a spiral track.

According to the first invention, the recording medium Is provided that is convenient to carry compared to a conventional disc-like recording medium. The inventive recording medium has the optically readable recording region, which brings about an increased memory capacity and is convenient to carry. In addition, by constructing the recording medium so as to have a composition similar to that of a widely used recording medium such as a CD, compatibility is ensured and such mediums can be manufactured at reduced cost.

The second invention provides a recording medium controlling apparatus for reading/writing data from/to a recording data area formed on a non-circular recording medium while rotating the recording medium, said apparatus comprising: detecting means for detecting a discontinuity in the recording tracks due to the non-circularity of the recording medium; and combining means for data on recording data areas present before and after the discontinuity in a rotating direction of the recording medium and detected by said detecting means so that these data continue.

The detecting means may comprise optical detecting means for detecting the discontinuity optically. The detecting means may comprise light cutoff detecting means for detecting the discontinuity depending on if light applied to the recording medium during rotation of the recording medium is cut off or not. The detecting means may comprise position information detecting means for detecting the discontinuity based on information on a position of the discontinuity recorded on the recording medium or in an access control driver.

According to the second invention, even with a non-circular optical recording medium having any shape and a recording track that has a discontinuity therein, data recorded on recording track regions adjacent to both ends of the discontinuity in the track can be optically read out and then combined to provide a physically continuous effective record. In addition, provision of the recording track that has a discontinuity increases a data storage capacity correspondingly.

The present invention also provides a non-circular recording medium controlling apparatus for reading/writing data from/to a non-circular recording medium on which a read only area where data is recorded beforehand and an additionally writing area where data is additionally writable are provided, said apparatus comprising: driving means for rotating the non-circular recording medium; irradiating means for irradiating with light a data recording track that involves the read only area and the additionally writing area on the non-circular recording medium being rotated; sensing means for sensing a reflection of the light irradiated by said irradiating means, from the data recording track on the non-circular recording medium; track shape detecting means for detecting the shape of the data recording track based on a result of the sensing by said sensing means; and reading means for reading data recorded on the data recording track based on a result of the detection by said track shape detecting means.

According to the third invention, the shape of the data recording track is determined and then data is read out. Thus, data reading is performed effectively. Since the shape of the data recording track is determined by irradiating the non-circular recording medium with light and detecting reflected light from the medium. Thus, the track shape determination can be performed with a simple composition to achieve its object rapidly and reliably. In addition, since the non-circular recording medium is optically readable, the shapes of the data recording tracks on the recording medium can be determined, using an optical source and the reflected light sensing means to read data on the non-circular recording medium. In this case, the non-circular recording medium controlling apparatus is provided at low cost.

### BRIEF DESCRIPTION OF THE DRAWINGS

FIG. 1 is a plan view of a CD card as a non-circular recording medium;

FIG. 2 is a block diagram of one embodiment of a CD card reader according to the present invention;

FIG. 3A is perspective view of the card reader of FIG. 2;

FIG. 3B schematically illustrates a mechanism of the CD card reader of FIG. 2;

FIG. 4 illustrates how a non-circular recording track portion changes depending on recording track number;

FIG. 5 is a flowchart of operation of the CD card reader;

FIG. 6 is a block diagram of another embodiment of the inventive CD card reader;

FIG. 7 illustrates recording tracks and sectors on the CD card recording region;

FIG. 8 schematically illustrates another embodiment of the card rotating mechanism of the CD card reader of FIG. 6;

FIG. 9 is a flowchart of another operation of the CD card reader of FIG. 6;

FIG. 10 is a flowchart of a version of the operation of the CD card reader in FIG. 9;

FIG. 11 is a flowchart of another version of the operation of the CD card reader of FIG. 9;

FIG. 12 is a block diagram of still another embodiment of the inventive CD card reader;

FIG. 13 is a flowchart of another operation of the CD card reader of FIG. 12;

FIG. 14 illustrates another shape of the CD card;

FIGS. 15A-15C each are a flowchart of an outline of a read operation based on a recognized shape of the CD card;

FIGS. 16-20 each illustrate a CD card having a different shape;

FIG. 21 is a plan view of a CD card in a second embodiment of the present invention;

FIG. 22 illustrates in detail the composition of recording tracks and sectors on the CD card of FIG. 21;

FIG. 23 is a perspective view of a drive device according to the present invention;

FIG. 24 is a detailed perspective view of a pickup unit of the drive device of FIG. 23;

FIG. 25 is a block diagram of a control system of the drive device of FIG. 23;

FIG. 26 illustrates the internal composition of a buffer memory of FIG. 25;

FIG. 27 is a flowchart of operation of the drive device of FIG. 23;

FIG. 28 is a detailed flowchart of a data reading process shown in FIG. 27;

FIG. 29 is a detailed flowchart of a data writing process shown in FIG. 27;

FIG. 30 is a plan view of a modification of the CD card of FIG. 21;

FIG. 31 is a perspective view of a pickup unit of a third embodiment;

FIG. 32 is a flowchart of a drive device with the pickup unit of FIG. 31;

FIG. 33 is a detailed flowchart of a data reading process shown in FIG. 32;

FIG. 34 is a flowchart of a more detailed data writing process shown in FIG. 32;

FIG. 35 is a flowchart of operation of a drive device in a fourth embodiment;

FIGS. 36A and 36B are a perspective view and a plan view, respectively, of a game device in a fifth embodiment of the present invention;

FIGS. 37A and 37B schematically illustrate the respective compositions of a read only area and an additionally writing area, respectively, of a memory area of a CD card used in the game device of FIG. 36;

FIG. 38 is a flowchart of operation of the game device of FIG. 36;

FIG. 39 is a perspective view of a game device in a sixth embodiment of the present invention; and

FIG. 40 is a perspective view of a game device in a seventh embodiment of the present invention.

### DESCRIPTION OF THE PREFERRED EMBODIMENTS

### First Embodiment

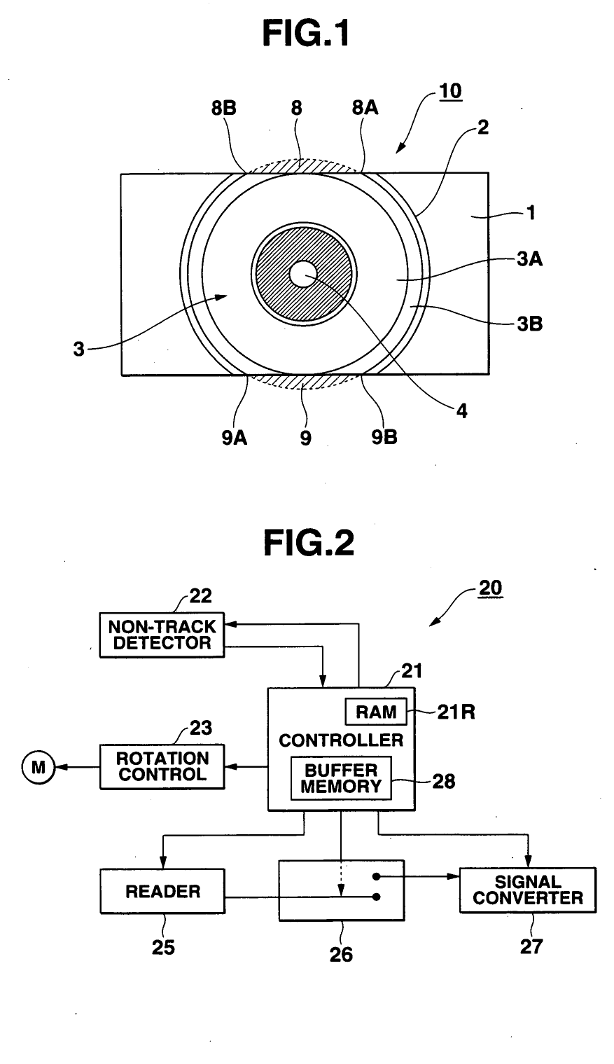

FIG. 1 illustrates discontinuous track portions formed on a non-circular or rectangular CD card 10. The CD card 10 has on its body a CD section 2 that includes a recording area 3, which in turn includes a circular recording area 3A and an outer non-circular concentric recording area 3B.

The shape of the CD section 2 is restricted by the rectangular shape of the card body 1. In FIG. 1, reference numerals 8 and 9 denote hatched virtual area portions of a completely circular disc missing in conformity to the shape of the rectangular card body 1. Reference characters 8A, 8B, 9A and 9B denote borderlines of the non-circular recording area 3B by which the respective circular recording tracks are partially interrupted.

Next, a method of detecting missing or chipped portions of the recording tracks on the CD card, using a CD card reader, and methods of accessing and combining data on the CD card will be described.

1. The Method of Detecting Missing or Chipped Portions of the Recording Tracks:

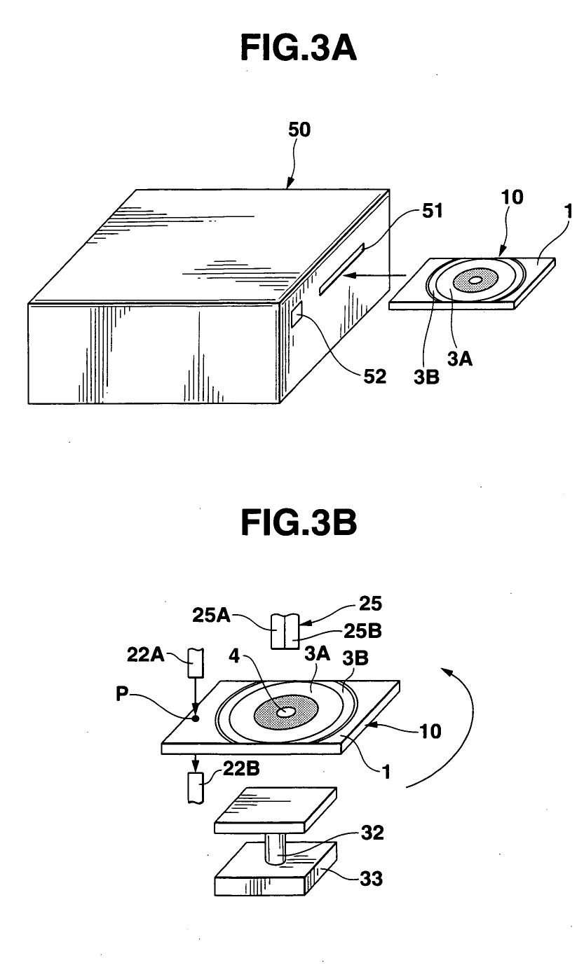

FIG. 2 is a block diagram of one embodiment of the CD card reader according to the present invention. FIG. 3A is a perspective view of the CD card reader. FIG. 3B schematically illustrates a reading mechanism of the reader.

FIG. 2 illustrates that the CD reader 20 includes a controller 21. Alternatively, the CD reader 20 may be controlled by a separate device (for example, a personal computer (PC)) to which the CD reader 20 is connected, without including the controller 21. In this case, a CD read driver is required to be installed in advance in the PC.

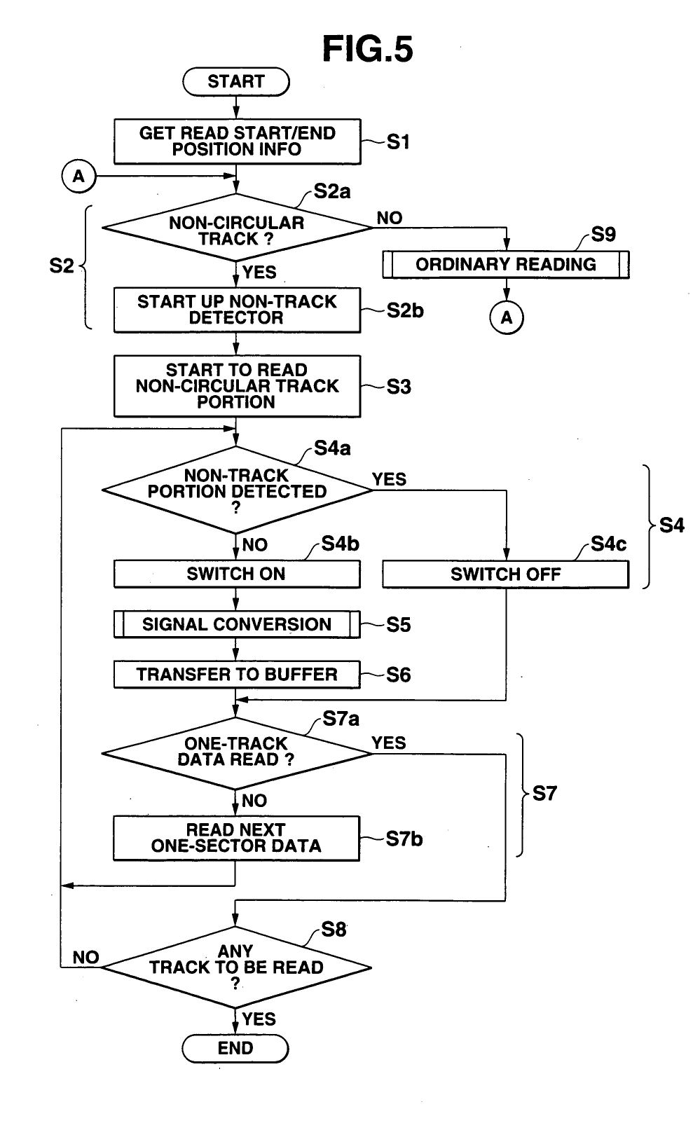

In FIG. 2, the controller 21 controls the whole operation of the card reader 20. The controller 21 determines a skip position and a skip timing on the non-circular recording track based on a non-circular recording track detection signal and a recording track number output in a reading process of FIG. 5 following a program stored in the card read driver.

When the controller 21 receives the non-circular recording track detection signal from a non-circular recording track detector 22, it determines a skip position or timing on the non-circular recording track in accordance with a recording track number related to the non-circular recording track detection signal.

A non-circular or circular recording track detector 22 which detects either discontinuities, i.e. missing track portions 8, 9 of the non-circular recording area 3B or existing recording track portions of the card 10 includes a light emitting unit 22A and a light detecting unit 22B, as shown in FIG. 3B. When the card 10 is rotated to cut off light from the light emitting unit 22A with the card medium, a recording track detection signal is delivered to the controller 21 whereas when the light detecting unit 22B receives light from the light emitting unit 22A, the detector 22 sends a non-circular recording track detection signal to the controller 21.

A rotation control unit 23 receives a control signal from the controller 21, and controls the driving of a rotational motor M1 that rotates the CD card 10 around a center hole 4 in the track.

An optical reader 25 optically reads out information written in the recording area 3 on the CD card 10. As shown in FIG. 3B, the optical reader 25 comprises a laser beam emission unit 25A which emits a laser beam against a recording track on the recording area 3 of the CD card 10, and a laser beam detection unit 25B which receives and detects reflected light from the recording track.

A changeover switch 26 inputs an output signal from the optical reader 25 to a signal converter 27 or interrupts input of the output signal from the reader 25 to the signal converter 27, depending on a result of the detection by the track detector 22.

The signal converter 27 converts an (optical) output signal from the optical reader 25 to an electric series signal while the track detector 22 is detecting the recording track. The signal converter 27 includes a serial/parallel converting unit that converts the serial signal to unit data of a predetermined number of bits.

In the example of FIG. 2, the controller 2 1B of the card reader 20 includes a buffer memory 28, which may be provided on the side of the PC.

FIG. 3 shows the CD reader of FIG. 2. FIG. 3A shows a housing 50 in which the card reader 20 is received. FIG. 3B schematically shows one embodiment of a card rotating mechanism of the card reader 20.

The CD reader housing 50 has on its side a port 51 through which a movable guide (not shown) on which the CD card 10 is placed is moved through the port into, or out of, the housing 50. The housing also has a button 52 to move the movable guide into/out of the housing.

When the user pushes the button 52, a movable-guide chive motor (not shown) moves the movable guide through the port 51 to the outside. When the user again pushes the button 52 with the movable guide on which the CD card 10 is placed, the movable guide is moved along with the CD card 10 into the housing 50 through the port 51.

When the CD card 10 is accessed, it is rotated along with a fixed base 33 by the motor M1. The optical reader 25 emits a reading beam from the laser emitting unit 25A. The reflected light detecting unit 25B receives or detects reflected light from a surface of the CD card 10, reads information recorded on a sector specified in accordance with a control signal from the optical reader 25, and then outputs it as an electric signal.

The track detector 22 includes an upper light emitting unit 22A and a lower light detecting unit 22B between which the CD card 10 is placed so that light emitted from the light emitting unit 22A is detected by the light detecting unit 22B. The presence of a non-circular recording track on the CD card is detected by the presence of detected light at the light detecting unit 22B (step S4 of FIG. 5).

Alternatively, the light emitting and detecting units 22A and 22B of the track detector 22 may be provided together above or below the CD card 10 so that light emitted from the light emitting unit 22A and reflected by the CD card 10 is detected by the light detecting unit 22B. In this case, when no light is detected, it is meant that there is a non-circular recording track.

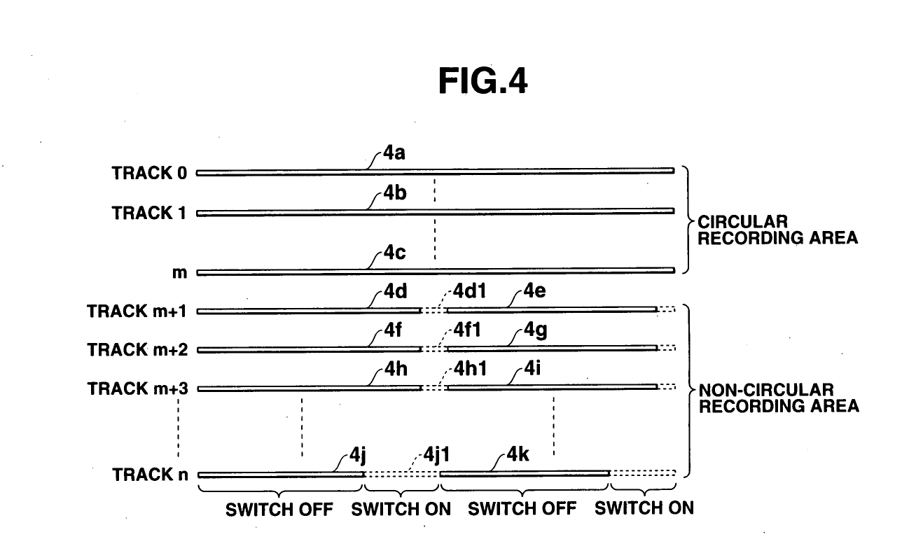

FIG. 4 illustrates the states of circular and non-circular recording tracks on the CD card 10 identified by the respective recording track numbers. The recording area of the disc-like recording medium comprises sectors defined by concentric recording tracks and radial lines each sector constituting a unit of access (FIG. 7) (when the recording medium has one recording track and no radial lines, it is handled as one sector). The respective tracks are allocated numbers “0”-“n” and the sectors allocated numbers “1”-“j”. A particular recording track (e.g. recording track “0”) has recorded track information on bad recording tracks, bad sector numbers, good recording track numbers, disc radii, etc).

The recording tracks “0”-“m” are completely circular on a circular recording area 3A within the rectangular shape of the card 1 (FIG. 7). Tracks m+1-n are on a non-circular area 3B restricted by the shape of the cardbody 1.

In FIG. 4, solid straight lines 4a-4k each denote a quantity of information recordable on a respective recording track. Broken-line portions 4d1, 4f1, 4h1 and 4j1 each denote a quantity of information unreadable due to restriction by the rectangular shape of the card body 1.

When the recording tracks are circular, the respective quantities of information recordable on the recording tracks are the same or substantially the same. Quantities of information recordable on the respective sectors formed by the recording tracks and radial lines segments passing through the disc are the same (a quantity of information recordable on each sector is represented by M=N/S where N and S denote a quantity of information recordable on a recording track and the number of sectors of each recording track, respectively). (M+1)^{th}-N^{th} recording tracks on the CD card 10 are-non-circular, and a whole recordable (=readable) quantity of information is NB<N, and NB=N−Tₘ₊ᵢ where Tₘ₊ᵢ denotes a quantity of information unreadable on the (m+i)^{th} recording track (the broken-line portion of FIG. 4; 0≦i≦n). The shapes of the unreadable portions are different depending on the respective recording tracks and hence quantities of unreadable information are different depending on the respective recording track numbers, as shown in FIG. 4.

In the (m+i)^{th} or more recording track, a quantity of unreadable information increases as the track number increases. In this case, the track detector 22 is required to be set so that a light beam emitted from the light emitting unit 22A hits a point outside the completely circular track on the card 10 (point P in FIG. 3B).

FIG. 5 is a flowchart indicative of operation of the card reader of FIG. 2. Step S1 represents acquiring information on read start/end positions. In this step, the controller 21 sends a control signal to the rotation control unit 23 to rotate the fixed base 22 on which the card 10 is placed to thereby read a recording track “0”. The controller 21 determines or acquires access parameters indicated by read start and end positions (a recording track number and a sector number) based on input/output record parameters (variables) given by an application program (executed by the PC), and information on an effective recording track and an effective sector on the recording track “0”, and then stores those parameters in a temporary recording memory 21R that includes a RAM.

Step S2 determines if a non-circular recording track is included. In step S2, the controller 21 checks to see if a recording track to be read comprises a non-circular one (step S2a). If it does, the controller 21 determines this fact. Step S2b is next. If otherwise, the controller 21 determines that the track is circular. Step S9 is next.

If the track is non-circular in step S2a, the controller 21 starts up the track detector 22 in step S2b to thereby light up the light emitting unit 22A.

The presence/absence of a non-circular track portion is known depending on if the recording track number ≧m+1, which is performed after information on the read end portion was acquired in step S1.

Step S3 represents starting to read data from the non-circular recording track portion. In step S3 the controller 21 sends a control signal to the optical reader 25 to start to read one-sector data from a non-circular recording track portion indicated by the access parameters. When the CD comprises one recording track that is one sector, the controller starts to read data from the one recording track.

Step S4 represents changeover control. In step S4 when an optical signal emitted by the light emitting unit 22A is cut off by the card 10 and does not enter the light detecting unit 22B, the track detector 22 sends a null recording track detection signal (=0) to the controller 21. Conversely, when the light signal emitted by the light emitting unit 22A enters the light detecting unit 22B due to rotation of the card 10, the track detector 22 sends a non-circular recording track detection signal (=1) to the controller 21.

The controller 21 monitors a detection signal from the track detector 22. When the controller 21 receives the recording track detection signal (=0), it turns on the changeover switch 26. Step 5 is next. Conversely, when the controller 21 receives the non-circular recording track detection signal (=1), it turns off the changeover switch 26. Step S7 is next.

Step S5 represents performing signal conversion. In step S5 when the changeover switch 26 is turned on in step S4, the signal converter 27 converts an optical signal received from the optical reader 25 to an electric signal, and performs serial/parallel conversion on the electric signal to thereby produce digital data of a predetermined bit length (for example, of 8 bits=1 bite).

Image/acoustic data need not be subjected to serial/parallel conversion. When an arrangement is provided so that before reading, input/output record parameter as well as a data type specifying parameter are received from the application program in step S1 and that the signal converter 27 selectively performs the serial/parallel conversion depending on the data type, the image/ acoustic data need not be subjected to serial/parallel conversion.

Step S6 represents transferring converted data to a buffer memory 28. In step S6 the controller 21 transfers the digital data converted by the signal converter 27 to the buffer memory 28 so that the transferred data is recorded sequentially in that order in the buffer memory 28.

When one-sector data is recorded, the controller 21 waits for occurrence of a vacancy in the buffer memory 28, at which time control passes to step B7.

Step B7 represents determining completion of reading the recording track. In step S7 the controller 21 reads recorded information on the present recording track or information on the final reading sector indicated by the access parameters. When this reading ends in step S7a, step S8 is next. If otherwise, the controller 21 reads the next one-sector data (step 7b). Step S4 is next.

Step S8 represents determining if reading the next recording track should be read or not. When the controller 21 determines in step S7 that the recording track contains a-final reading sector indicated by the access parameters, the controller 21 terminates the reading process in step S8. If otherwise, control returns to step S4.

Step S9 represents performing usual reading process. In step S9 the controller 21 turns on the changeover switch 26 to cause the optical signals read sector by sector by the optical reader 25 to be input sequentially to the signal converter 27 for signal conversion and also to be transferred to the buffer memory 28. When the controller 21 reads the final reading sector indicated by the access parameters is read, the controller 21 terminates the reading operation and then reads recorded information on the present recording track. Step S2 is next.

The data on the non-circular recording track transferred to the buffer memory 28, or present adjacent to opposite ends of the discontinuities skipped by the optical reader 25, are combined in the buffer memory 28.

In other words, according to this composition, even when there are a plurality of discontinuities or non-recording portions related to the non-circular recording track portions due to the non-circular shape of the CD card 10, the respective discontinues or non-recording portions are skipped and data present on ends of the recording track portions between which the skipped non-circular portion exists can be read in order to be combined to thereby maintain the continuity of the read data.

In this arrangement, information on the positions of the discontinuities or non-recording portions and recording track portions need not be recorded on particular recording track unlike other embodiments to be described later. Thus, the composition of the recording area of the CD card is simplified.

Also, information on the positions of the discontinuity or non-recording portions and non-circular recording track portions need not be stored in the driver unlike the other embodiments. Thus, the size of the driver is not large.

This composition is suitable for reading image or acoustic data on one recording track that comprises one sector.

2. An Example in Which the Discontinuity or Non-Recording Portion is Determined Based on the Border Positions of Non-Circular Recording Portions:

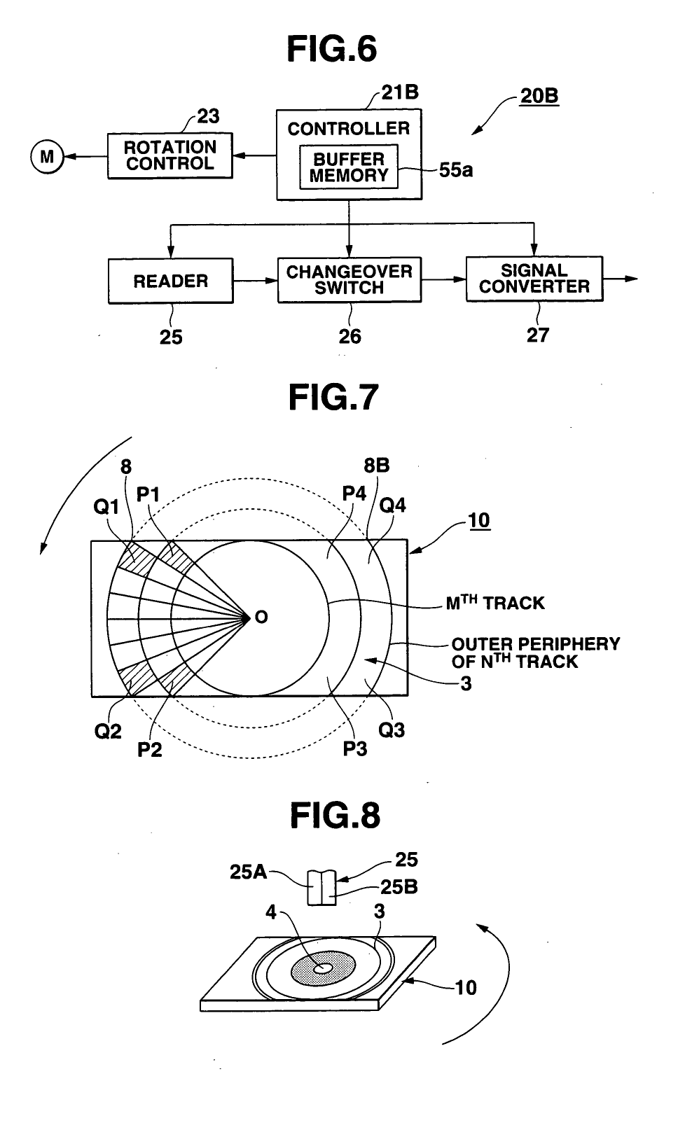

FIG. 6 is a block diagram of another embodiment of the inventive CD card reader. The reader 20B has the same composition as the card reader 20 of FIG. 2 excluding the track detector 22 based on mechanical rotation of the card. In addition, the controller 21B of the card reader 20B is different from the controller 21 of the card reader 20 of FIG. 2.

FIG. 7 illustrates recording tracks and sectors on a recording area 3 on the CD card 10. In the CD card 10, the physical recording area 3 is divided into n concentric recording track areas which are each divided further by radial lines into k sectors for managing purposes.

The recording area 3 may include only one recording track=one sector to be managed.

In FIG. 7, an m^{tb} recording track is the outermost one of the circular concentric recording tracks. (M+1)^{th}-n^{th} recording tracks are non-circular. The sectors are formed by dividing the concentric tracks with k radial straight lines passing through the center O of the circular concentric recording tracks and spaced at equal angles. In the case of each circular track, the number of sectors is k. In the case of a non-circular track, the number of sectors of the (m+1)^{th} recording track>that of the (m+2)^{th} recording track> . . . >that of the (n−-1)^{th} recording track>that of the n^{th} recording track.

When the positions of opposite end sectors of each non-circular recording track portion (in FIG. 7, opposite sectors P1, P2 and P3, P4 of the (n−1)^{t}k recording track portion; opposite sectors Q1, Q2 and Q3, Q4 of the nth recording track portion) are recorded on a specified recording track or in the driver, the recording tracks and the discontinuities or non-recording portions can be discriminated from each other in the read operation.

Instead of recording the positions of the sectors, angles θ1-θn each included between two straight radial lines which combine the center of the circular recording track and the respective opposite ends of a non-circular recording track portion may be stored on the specified recording track or in the driver.

FIG. 8 schematically illustrates an embodiment of a card rotating mechanism of the card reader of FIG. 6. This card reader records on the specified recording track or in the driver the positions of the opposite end sectors of each non-circular recording track. This composition is the same as that of FIG. 3B free from the non-circular recording track detector 22 (light emitting unit 22A and light detecting unit 22B).

2-1. An Example Where the Numbers of the Opposite End Sectors of the Non-Circular Recording Track are Recorded in a Specified Sector:

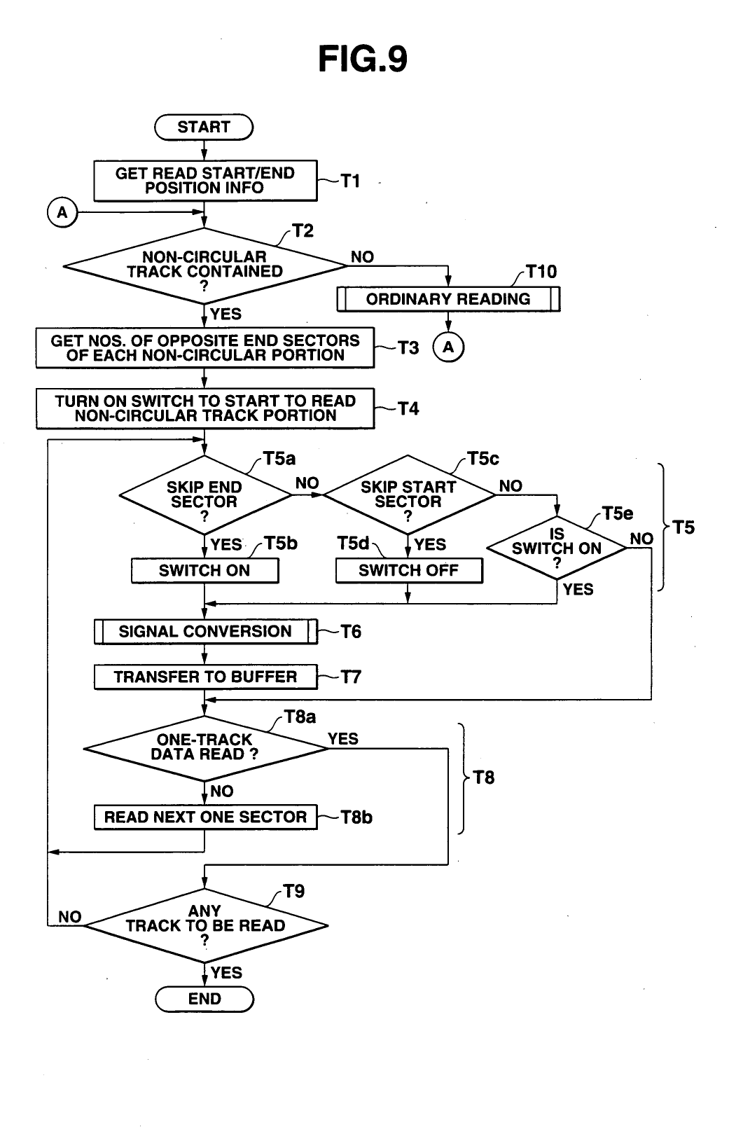

FIG. 9 is a flowchart of operation of the CD card reader of FIG. 6. In this example, a recording track “0” has recorded recording track numbers and a plurality of pairs of sector numbers, each pair of sector numbers representing a pair of opposite end sectors of each of a pair of non-circular recording track portions in a recording track indicated by a respective one of the recording track numbers. Those sector numbers may be recorded on the recording track “m”.

Step T1 of FIG. 9 represents acquiring information on read start/end positions. In step T1, controller 21B sends a control signal to the rotation control unit 23 to rotate the base 32 to which the CD card 10 is fixed to thereby read the recording track “0”, determines or acquires access parameters indicated by the read start/end positions based on input/output record parameters given by the application concerned, and information on effective recording track portions and effective sectors of the recording track “0”, and then stores them in RAM.

Step T2 represents determining if a non-circular recording track portion is included. In step T2, controller 21B checks to see if a target recording track to be read includes a non-circular recording track portion. If otherwise, controller 21B determines that the track is circular. Step T10 is next. If it does, step T3 is next.

The presence of the non-circular recording track portion can be known depending on if the read end recording track number involving the information on the read end portion acquired in step T1 is equal to, or larger than, m+1.

Step T3 represents acquiring information on opposite end positions of the non-circular recording track portion. In step T3, controller 21B delivers a control signal to the optical reader 25 to acquire two pairs of sector numbers of corresponding pairs of opposite end sectors P1, P2; P3, P4, i.e. skip end and start sectors P1 (P3) and P2 (P4), each pair of opposite end sectors being of a respective one of a pair of non-circular recording track portions contained in a track indicated by a track number (m+1) related to the read start and end positions acquired in step T1 from among the track numbers of the tracks and the plurality of pairs of opposite end sectors of each of the pair of non-circular recording track portions included in each of the plurality of tracks represented by a respective one of the recording track numbers.

In the example of FIG. 7, when it is assumed that the CD card 10 is rotated counterclockwise, reference characters P1 and P3 each denote a skip start sector number in the recording track “n−1”, and P2 and P4 each a skip end sector number.

Step T4 represents stating to read data from the non-circular track portion. In step T4, controller 21B delivers a control signal to the optical reader 25 to start to read one-sector data from the non-circular recording track indicated by the access parameters. In the case of one recording track=one sector, controller 21B starts to read data on the one recording track. At this time, the changeover switch 26 is turned on.

Step T5 represents switch control. In this step T5, controller 21B compares the sector number and related track number read in step T4 with information on the opposite end positions (recording track number and sector numbers) of the non-circular recording track potion acquired in step T3.

When the read sector is a skip end sector as a result of the comparison in step T5a, the changeover switch 26 is turned on in step T5b. Step T6 is next. If the read sector is a skip start sector in step T5c, the changeover switch 26 is turned off in step T5d. Step T6 is next. If the read sector is neither the skip start sector nor the step end sector in step T5e, step T6 or T8 is next depending on the value of the changeover switch. If the changeover switch 26 is on, T6 is next. If the changeover switch 26 is off, none of the steps T6 and T7 are performed. Step T8 is next.

Step T6 represents signal conversion. In step T6, signal converter 27 receives an optical signal from the optical reader 25 and converts it to an electric signal. The converter 27 further performs serial/parallel conversion on the electric signal to produce digital data of a predetermined bit length (foe example, of 8 bits=1 bite). Image/acoustic data need not be subjected to serial/parallel conversion.

Step T7 represents transfer to buffer memory 28. In step T7, controller 21B transfers converted digital data output from signal converter 27 to buffer memory 28. The transferred data is moved back to the rear and recorded in order in buffer memory 28. When one-sector data is recorded, controller 21B waits for occurrence of a vacancy in buffer memory 28. Step T8 is next.

Step T8 represents determining an end of the track reading. In step T8, when controller 21B reads recorded information on the present recording track or the final reading sector indicated by the access parameters and the reading then ends in step T8a, it passes the control to step T9. If otherwise, in step T8b controller 21B reads the next one-sector data. Step T5 is next.

Step T9 represents determining if the next recording track should be read or not. When controller 21B determines that the recording track contains a final read sector indicated by the access parameters, in step T9 the controller terminates the reading. If otherwise, the controller returns the control to step T5.

Step T10 represents an ordinary reading process. In this step, controller 21B turns on changeover switch 26 and then performs a usual reading process similar to step S9 of FIG. 5 to read a final read sector indicated by the access parameters. At this time the controller 21B terminates the reading process. When the controller reads recorded information on the present recording track, it returns the control to step T2.

By the above arrangement, the non-recording region present between the non-circular recording track portions can be skipped and only information recorded on the non-circular recording track portions can be read. Since the transferred digital data is stored sequentially in order in the buffer memory 28, the transferred data present before and after the skipped region or discontinuity can be combined in the buffer memory 28.

According to such arrangement, no detectors for detecting non-circular recording track portions are required compared to the examples of FIGS. 2-5 that detects the non-circular recording track portions optically. Thus, the composition of the optical reader is simplified.

2-2. An Example in Which the Sector Numbers of Opposite End Sectors of Each Non-Circular Recording Track Portion are Recorded in the Driver:

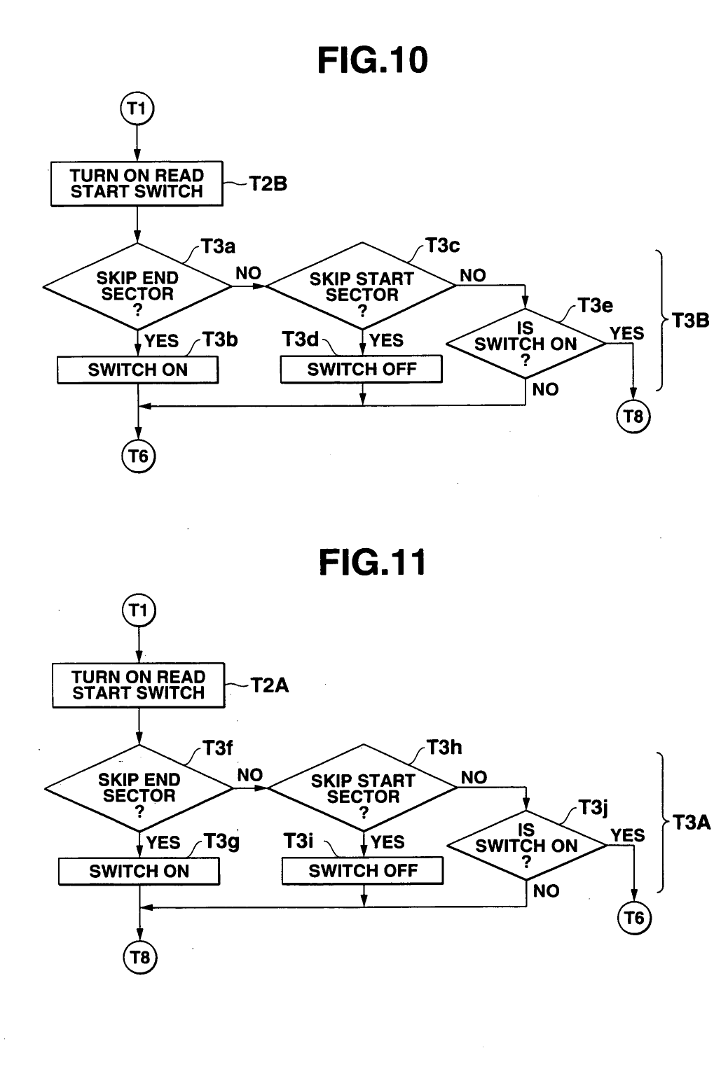

FIG. 10 is a flowchart of another operation of the CD card reader of FIG. 6. In this example, a plurality of track numbers, each representing a track that contains a pair of non-circular recording track portions, and a plurality of pairs of sector numbers, each pair of sector numbers representing opposite end sectors of each of a pair of non-circular recording track portions included in a track indicated by a respective track number are beforehand registered on a skip position registration table of the driver.

In FIG. 10, operation of step T1 and operations of step T6 and subsequent steps are similar to corresponding ones of FIG. 9 except that in FIG. 9, steps T8 and T9 return to step T5 whereas in FIG. 10, steps T8 and T9 return to step T3B.

Step T2B of FIG. 10 represent starting to read data. In this step, after information on the read start/end positions in step T1 is acquired, controller 21B delivers a control signal to the optical reader 25 and starts to read one-sector data from the sectors of a recording track indicated by the access parameters. In the case of one recording track=one sector, controller 21B starts to read the one-recording track data. Changeover switch 26 is turned on.

Step T3B represents switch control. In this step, controller 21B compares the read sector number with the recording track number and sector number recorded on the position registration table of the driver. In step T3a if the read sector represents a skip end sector, in step T3b changeover switch 26 is turned on. Step T6 is next.

In step T3c if the read sector is a skip start sector, in step T3d changeover switch 26 is turned off. Step T6 is next. If the read sector is neither the skip start sector nor the skip end sector, in step T3e the value of the changeover switch 26 is determined. Step T6 or T8 is next selected depending on the value of the changeover switch 26. If changeover switch 26 is off, step T6 is next whereas if the changeover switch 26 is on, T8 is next by skipping steps T6 and T7.

In the above arrangement, only information recorded on the opposite end sectors of each of the non-circular recording track portions can be read while skipping the related non-recording portion or discontinuity, for combining purposes.

Such arrangement provides a simplified optical reader since no track detector need be provided compared to the examples of FIGS. 2-5 that illustrates optical detection of the non-circular recording track portion.

In this example, the composition of the recording area of the CD card may be simple compared to the example of FIG. 9 in which the sector numbers of the opposite end sectors of each recording track portion are recorded in the specified recording track.

2-3. An Example in Which Marks Recorded on Opposite Ends of a Non-Circular Recording Track Portion are Used to Determined the Non-Circular Recording Track Portion:

FIG. 11 is a flowchart of another operation of the CD card reader of FIG. 6. In this example, a pair of special marks are each recorded in manufacture on a respective one of opposite end sectors of a non-circular recording track portion. For example, in the case of the skip start sector, a mark is made of a first “0” bit and all other remaining “bits”. In the case of the skip end sector, a mark is made of all “1” bits.

In FIG. 11, the operation of step T1 and operations of step T6 and subsequent steps are similar to corresponding ones of FIG. 9 except that steps T8 and T9 of FIG. 9 return to step T5 whereas steps T8 and T9 of FIG. 11 return to step T3A.

In FIG. 11 step T2A represents a start of data reading. After acquiring information on the read start/end positions in step T1, in step T2A controller 21B sends a control signal to the optical reader 25 to start to read one-sector data from a recording track sector indicated by the access parameters. When one recording track comprises one sector, controller 21B starts to read the one-recording track data. Changeover switch 26 is turned on.

Step T3A represents switch control. In this step, controller 21B checks the read sector data. If the data is made of a first “0” bit and all other “1” bits, the controller determines that the sector read in step T3f is a skip end sector, and turns on changeover switch 26 in step T3g. Step T8 is next.

If the read sector is made of all “1” bits, the controller determines in step T3h that the read sector is a skip start sector, and turns off changeover switch 26 in step T3i. Step T8 is next. If all bits of the read sector are 1 except for the first bit, T6 or T8 is next depending on the value of changeover switch 26 in step T3j. If changeover switch 26 is on, step T6 is next. If changeover switch 26 is off, step T8 is next by skipping steps T6 and T7.

By the above arrangement, data can be read so that only information recorded on sectors of the recording track portions can be combined mutually, by skipping the related non-recording track portion.

In this arrangement, the composition of the optical reader is simplified since no non-circular recording track detectors need be provided, compared to the examples of FIGS. 2-5 which detects the non-circular recording track portions optically.

3. An Example in Which Null Data is Deleted After Being Temporary Transferred to Buffer Memory 28:

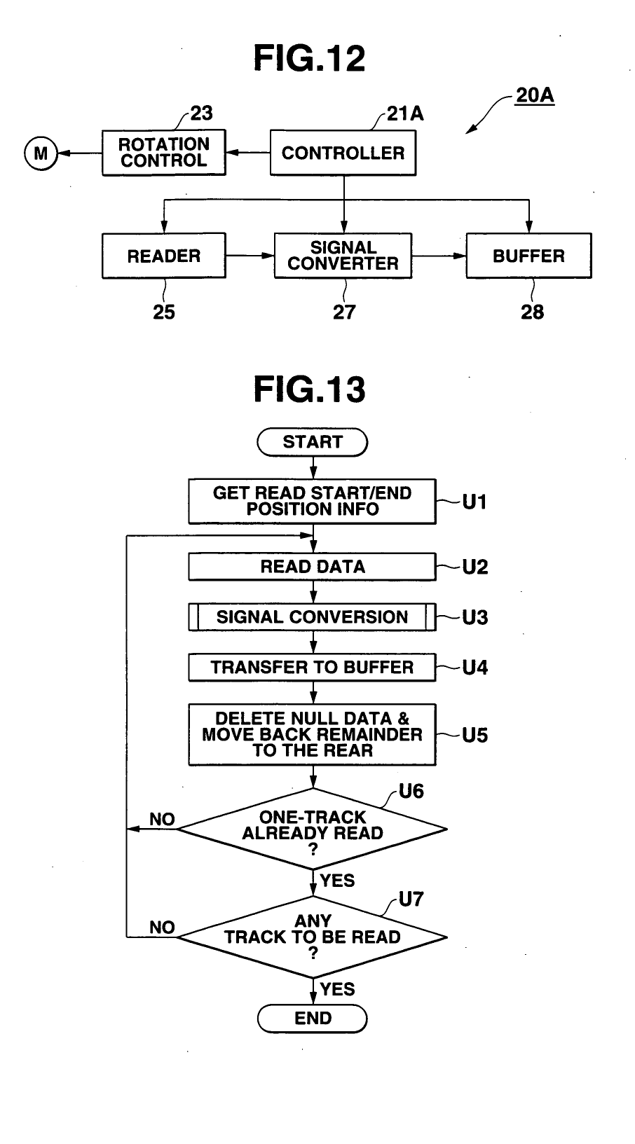

FIG. 12 is a block diagram of one embodiment of the inventive CD card reader. The CD card reader 20A has a composition of the CD card reader 20 of FIG. 2 free form the non-circular recording track detector 22 and the changeover switch 26. The other functions of the CD card reader 20A are similar to corresponding ones of the CD card reader 20 of FIG. 2 except for the function of the controller 21A.

FIG. 13 is a flowchart of operation of the CD card reader of FIG. 12. Step U1 of FIG. 13 represents acquiring information on a read start/end positions. In step U1 controller 21 A of FIG. 12 sends a control signal to the rotation control unit 23 to rotate a base 32 to which a CD card is fixed, reads a recording track “0”, determines or acquires access parameters shown by the read start and end positions based on the input/output record parameters given by the application concerned, and effective recording track portions and their effective sectors in the “0” recording track, and then stores them in RAM.

Step U2 represents data reading. In this step the controller 21A sends a control signal to the optical reader 25 to read one-sector data from the recording track sector indicated by the access parameters. When one recording track comprises one sector, the controller 21A reads data on the one recording track.

Step U3 represents signal conversion. In this step the signal converter 27 receives an optical signal from the optical reader-25 and converts it to an electric signal, and then performs serial/parallel conversion on the electric signal to produce digital data of a predetermined length (for example, of 8 bits=1 bite). Image/acoustic data need not be subjected to serial/parallel conversion.

Step U4 represents transfer to buffer memory 28. In this step, the controller 21A transfers digital data converted by the signal converter 27 to buffer 28. The transferred data is sequentially stored in order in buffer memory 28. When one-sector data is recorded, controller 21A passes its control to step U5.

Step U5 represents deletion of null data. In step U5, controller 21A detects null data involving a discontinuity or the appropriate one of the missing track portions 8 and 9 (FIG. 1), between the non-circular recording track portions 3B from the overall one-sector data stored in the buffer memory 28, deletes the detected null data, and rerecords the remaining data in order without excess vacant spaces in the buffer 28.

As described with reference to the flowcharts of FIGS. 5, 10 and 11, the start and end positions of the null data can be detected by recording information on the start and end of the null data or particular marks beforehand on the specified recording track, for example, numbered “0” or in the driver.

Step U6 represents determining an end of recording track reading. In this step, controller 21A waits for occurrence of a vacancy in the buffer 28 and then reads the information recorded on the present recording track or the final reading sector indicated by the access parameters. Step U7 is next. If otherwise, controller 21A reads the next one-sector data and waits for occurrence of a vacancy in the buffer 28, at which time the controller passes the control to step U2.

Step U7 determines if the next track should be read. When controller 21A determines in step U6 that the recording track comprises the final reading track indicated by the access parameters, in step U7 it terminates the reading operation. If otherwise, U2 is next.

By such arrangement, even when there are two or more non-circular recording track portions along a simple track on the card due to the card shape, the non-track portions or discontinuities can be skipped and only information recorded on the non-circular recording track portions can be read out for combining purposes.

In this arrangement, neither the track detector 22 nor the changeover switch 26 is required to thereby simplify the circuit composition of the CD reader.

4. An Example in Which the Shape of a Card is Recognized and Data Then is Read from the Card:

In the example of FIG. 9 or 10, information on opposite end sectors of a non-circular recording track is recorded on the specified recording track or driver, and non-recording track portion is skipped based on the information on the end sectors of the recording track portion. In the example of FIG. 13, null data written in the buffer memory 28 is deleted based on the information on the opposite sectors of the recording track portion.

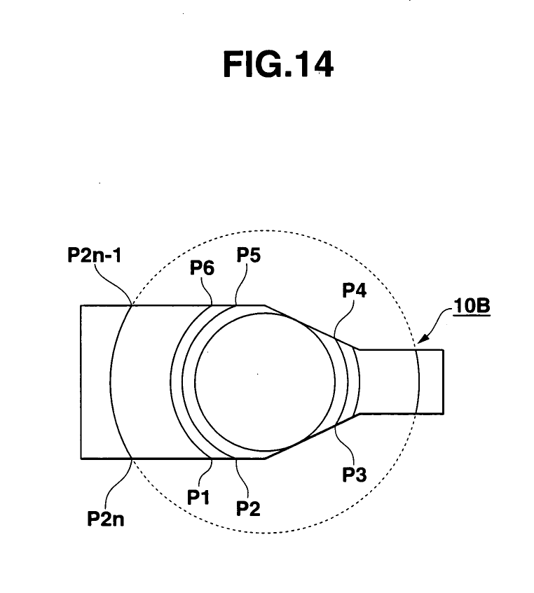

FIG. 14 shows another embodiment in which the shape of the CD card 10B is recognized and information on the opposite end sectors of the non-circular recording track portion is acquired. Skipping is made or null data is deleted based on the acquired information on the end sectors.

The CD card 10B takes the form of a tennis racket as a whole. In FIG. 14, reference characters P1-P2n show border points of the non-circular recording track portions.

If data on the CD card 10B shape and a recording track is known even when the CD card 10B takes such shape, border points P1-P2n can be calculated and the sector numbers of the opposite end or border sectors of the related non-circular recording track can be obtained.

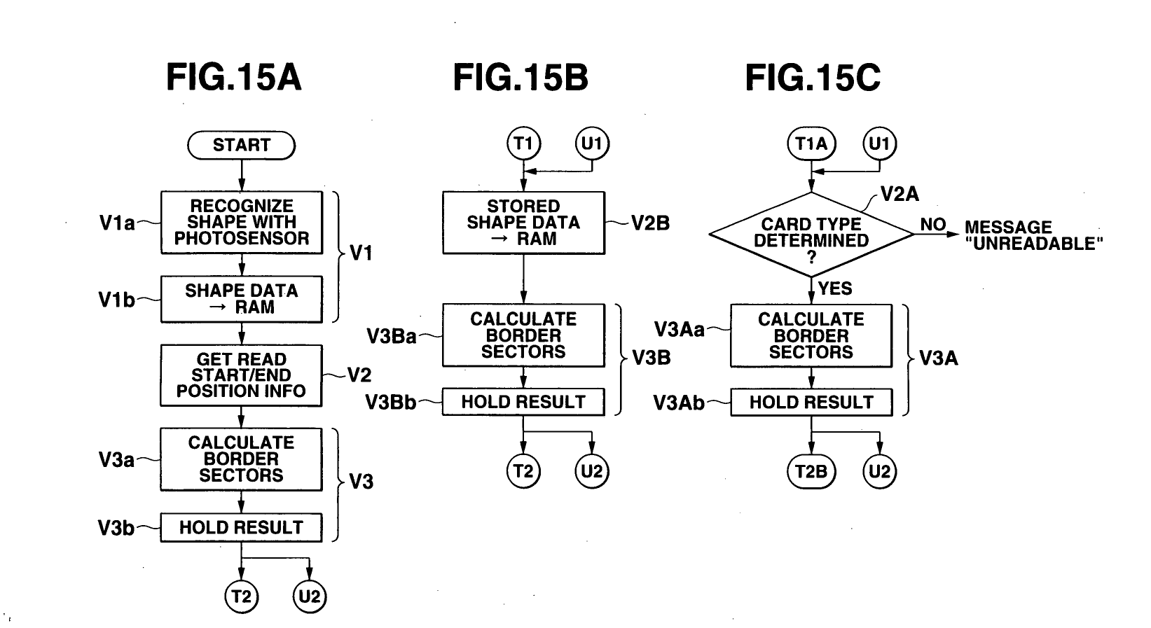

FIGS. 15A-C show flowcharts of reading data on non-circular track portions based on recognized shape data. FIG. 15A shows a method of recognizing the shape of the CD card 10B in reading. FIG. 15B shows a method of recording shape data beforehand on the CD card 10B. FIG. 15C illustrates a method of recording shape data beforehand on the driver.

(Shape Recognition)

Step V1 of FIG. 15A represents shape recognition. In step V1 the card reader 20B is started up. When the CD card 10 is inserted into the reader, the reader scans the overall card 10 with a shape sensor such as a photosensor (step V1a) to sense a contour of the rectangular card 10 and stores the resulting data in RAM (step V1b).

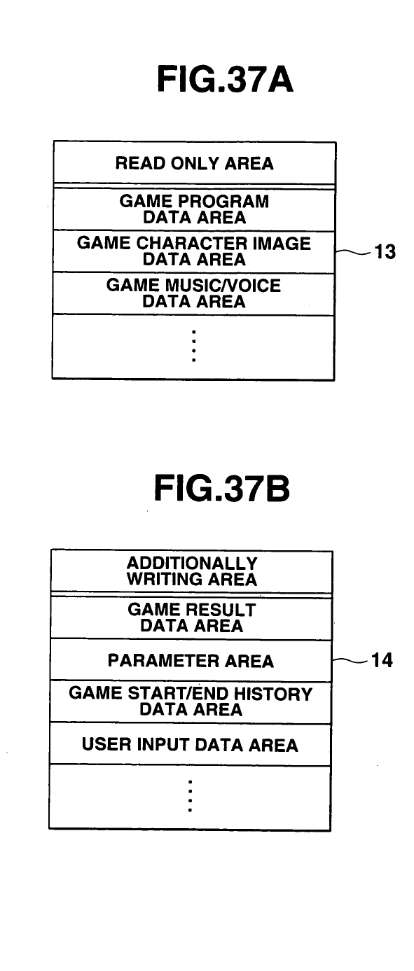

Step V2 represents acquiring information on read start/end positions. In step V2 controller 21B sends a control signal to rotation control unit 23 to rotate the base 32 (FIG. 37B) on which the CD card is fixed, reads the recording track “0”, and determines (or acquires) access parameters indicating the read start and end positions based on input/output record parameters given by the application concerned and information on effective recording tracks and effective sectors recorded on the recording track “0”, and then stores those parameters in RAM.

Step V3 represents calculation of opposite end or border sectors of a non-circular recording track portion. In step V3, controller 21B determines the opposite end or border sectors of the non-circular recording track portion based on the shape data acquired in step V1, and information on the read start and end positions and sectors acquired in step V2 (step V3a), and then stores the information on the border sectors in RAM (step V3b). Step T2 of FIG. 9 (or step U2 of FIG. 13) is next.

Thus, in step T3 of FIG, 9, the numbers of both the opposite end or border sectors of each of the non-circular recording track portions are obtained. In step U5 of FIG. 13 a section of null data to be deleted is obtained.

(An Example in Which the Shape Data is Recorded on the CD Card)

Step V2B represents reading the shape data recorded. In step V2B, controller 21B determines (or acquires) access parameters in step T1 of FIG. 9 (or step U1 of FIG. 13), stores the parameters in RAM, and then acquires data on the shape of the CD card from the recording track “0” or a recording track specified by the information recorded on the recording track “0”.

Step V3B represents calculation of border sectors. In this step V3B, controller 21B determines border sectors based on the shape data acquired in step V2B, and the information on the non-circular recording track portions and sectors acquired in step T1 of FIG. 9 (or step U1 of FIG. 13) (step V3Ba), and stores the data in RAM (step V3Bb). Step T2 of FIG. 9 (or step U2 of FIG. 13) is next.

Thus, as in FIG. 15A, the sector numbers of opposite end or border sectors of the non-circular recording portion are obtained in step T3 of FIG. 9. A section of null data to be deleted is obtained in step U5 of FIG. 13.

(An Example in Which the Shape Data is Recorded Beforehand in the Driver)

Step V2A represents determining a type of the CD card. In this step V2A, controller 21A determines (or acquires) access parameters in step T1 of FIG. 10 (or step U1 of FIG. 13), stores them in RAM, and then acquires data on the type of the CD card from the recording track “0” or a recording track specified by the information recorded on the recording track “0”.

Step V3A represents determining border or opposite end sectors. In this step V3A, controller 21A compares the type of the CD card acquired in step V2A with that of a CD card recorded in the driver. If both the types coincide, the controller determines border sectors based on data on the shape of the card recorded in the driver, and information on recording tracks such as the read start and end positions and sectors obtained in step T1 or U1 (step V3Aa), and then stores them in RAM (step V3Ab). Step T2 of FIG. 9 (or step U2 of FIG. 13) is next.

Thus, the sector numbers of the opposite end or border sectors of each of the non-circular recording track portions in step T3B of FIG. 10 and a section of null data to be deleted in step U5 of FIG. 13 are obtained.

5. An Example in Which a Track Portion Varying Depending on a Type of the CD Card Reader is Read:

As will be obvious from the explanation of the CD card of FIGS. 1, 7 and 14, the recording area of the non-circular CD card includes the circular recording track area 3A and outer non-circular recording area 3B that lacks a pair of arcuate track portions. Reading information from the respective circular recording tracks on the circular recording area 3A is easy compared to accessing the non-circular area.

In a portable card reader (for example, a portable acoustic reproducing device used for selecting and listening to a desired one from a plurality of pieces of music recorded on a circular recording area) whose size is required to be small, data recorded on the circular recording area 3A may be read. In a fixed type card reader (for example, a cash dispenser), information recorded on the recording area 3 (circular recording area 3A and non-circular recording area 3B) may be read. An area portion of the card to be read may be changed depending on a type of the card reader. A type of the card reader may be changed depending on a type of information recorded.

In this way, various kinds of data (character data, numerical data, acoustic data, and image data) can be recorded on the CD card. Since one CD card can be utilized for various purposes, a field of use of the CD card increases.

Since a single reader is not necessarily required to have a plurality of reading functions, each reader can be developed so as to fulfill a respective one of the purposes. Thus, such a reader having a single function is simple to handle compared to a reader having a multi-function and the failure or accident rate is reduced.

While in the above description the CD card has been described as storing information on the circular and non-circular areas 3A and 3B, an information recording area may be provided in a region of the CD section 2 other than the areas 3A and 3B. For example, an information recording area such as a magnetic stripes, IC memory or barcodes may be provided outside the outermost non-circular recording track n. Alternatively, such information recording area may be provided on the other surface of the card body 1.

In the above arrangement of the above-mentioned “5. An Example Where a Track Portion Varying Depending on a Type of the CD Card Reader is Read”, a non-rotational reading type card reader (or a conventional fixed-position reading type card reader) may be connected to the inventive CD card reader to read information recorded in an information recording section such as a magnetic stripe, IC memory or barcode on the CD card to thereby control access of the inventive CD card reader to a circular recording area 3B. The portable reader is usable to read information recorded on the circular recording area 3B. The fixed type reader is usable to read the overall CD card 10 (10B, 10A).

The information recorded on the information recording section of an IC memory or barcode can be easily read out. Thus, when rapid certification is required, the information is usable as first certifying means. For example, when the CD card is used as a season ticket at an automatic ticket gate of a station, or as a food ticket in a restaurant, at a peak of its congestion to certify the user' identity only with information recorded on an IC memory or barcode of the card, the user's identity is certified when the CD card passes through the ticket gate. Thus, ticket checking or food order would not be congested.

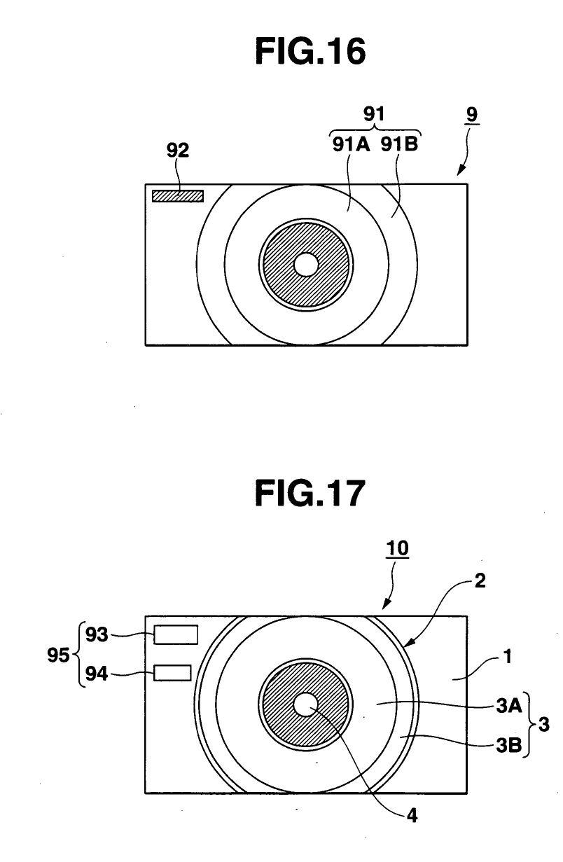

FIG. 16 illustrates a magnetic stripe provided on a CD card. In FIG. 16, the CD card 90 comprises a CD section 91 that includes a circular recording area 91A and outer concentric non-circular recording area 91B, and a magnetic stripe 92 provided outside the CD section 91. Recorded on the magnetic stripe 92 are a user (or employee's) number, his or her name and its effective term. Data on this card can be read in the conventional card reader when the employee has come to/leaves the office, orders some food or drink in the staff canteen, buys something in the cooperative store, uses a copying machine, and/or reads materials.

While in the above one embodiment of the present invention has been illustrated, the present invention is not limited to the embodiment. Various changes and modifications are possible, of course. For example, as shown in FIG. 17, a CD section 3 and a data recording section 95 outside the CD section 3 that includes a semiconductor memory 93 and a data carrier section 94 may be provided on a CD card so that data read from the CD section 3 is recorded on the data recording section 95.

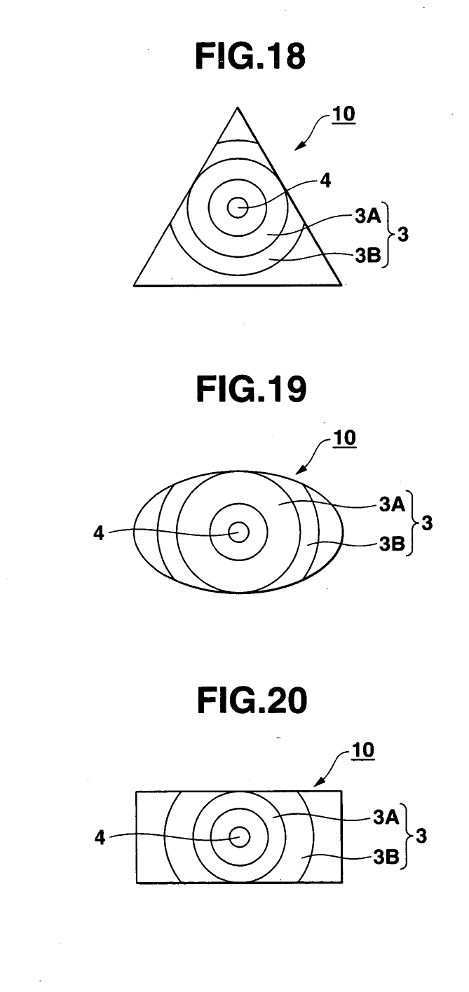

In addition to the rectangular shape of the cards,. as shown in FIGS. 1-17, the CD card 10 may take any one of non-circular forms (for example, square, polygonal, elliptical, star-like or animal shape-like), as shown in FIGS. 18-20.

The present invention is not limited to CDs, but applicable, for example, to DVDs and/or magnetic discs (MDs).

While in the present invention the non-circular card on which the CD section is provided to record/reproduce information optically is illustrated, a magnetic recording section (including a non-circular recording section and a concentrically circular magnetic recording section that records/reproduces information magnetically may be provided on the non-circular card, in place of the CD section. In this case, the non-circular card with the magnetic recording section is rotated so that the magnetic reader can read data on the card magnetically in a manner similar to that mentioned above.

According to the above methods of recording/reproducing data on the card medium, only data recorded on the circular recording track section other than the non-circular track sections can be read, combined and recorded, irrespective of the shape of the card. The data stored in this way can be read and reproduced.

Null data present on the non-circular portions can be erased from data read from a non-circular recording portion of a card having any shape and effective data present before and after the null data portion can be combined so as to keep continuity.

When the timing of cutting off light due to rotation of the card medium is detected, information on the start/end of the null data present on the non-circular portion need not be recorded, which simplifies the control.

When a section of cutting off light due to rotation of the card medium is detected, the null data section can be skipped. Thus, no information on the start/end of the null data need be recorded, which simplifies the control.

Since the non-circular recording track portions of the DC card are detected and the null data can be skipped based on the shape data, data can be read continuously in spite of the shape of the card used.

After the data is read from the card based on the shape data, the null data in the area following the non-circular recording track portion is erased and effective data are combined so as to be continuous. Thus, data can be read continuously from the CD card in spite of its shape.

A data area to be read can be changed depending on a type of the card reader. Alternatively, a type of the reader can be changed depending on a type of the recorded information. Thus, various kinds of data (for example, character data, numerical data, acoustic data or image data) can be recorded on the card medium. Thus, a single card medium can be used for various purposes, which enlarges the field of its use.

A single reader need not have a plurality of reading functions. Thus, different readers can be developed so as to fulfill their respective purposes. Thus, compared to a reader having a multi-function, a reader having a single function is easy to handle to thereby reduce a failure or accident rate.

### Second Embodiment

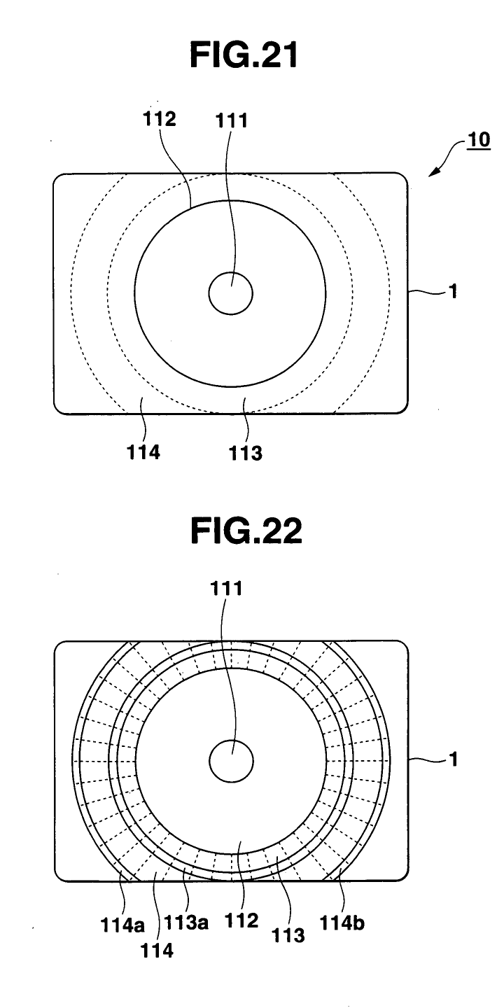

FIG. 21 is a plan view of a CD card 10 as a second embodiment of the present invention. As shown in FIG. 21., the CD card 10 having a body 1 comprises a substantially rectangular thin non-circular recording medium.

As shown in FIG. 21, the CD card body 1 has a circular support 112 that in turn has a circular hole 111 at its center, an outer concentric read only area 113 and an additionally recording area 114 concentric or spiral with the circular support 112 (hereinafter, “concentric” should also include “spiral”).

The support 112 takes the form of a transparent plastic disc, which is fixed to the CD card body 1 by fitting a predetermined jig into the hole 111 in the CD card body 1 in a drive device 105 to be described later.

The CD card body 1 has a similar composition to that of a CD-ROM (Compact Disc-Read Only Memory) in the drive device 105. The CD card body 1 is made of a pair of transparent plastic discs, for example, of polycarbonate and a reflective layer of a metal foil inserted between the pair of discs. One outer surface of the CD card body 1 constitutes a printed label surface whereas the other outer surface constitutes a recording surface.

A plurality of concentric recording tracks or a spiral recording track is formed in the read only area 113. The respective recording tracks are divided into sectors.

Each sector includes “pits” and a flat “land” representing digital data.

As described above, the CD card body 1 includes the inserted reflective layer of a metal foil. Thus, a laser beam with which the recording surface of the CD card body 1 was irradiated is reflected by the recording surface. In this case, the laser beam is diffused by the pits whereas the laser beam with which the land was irradiated is reflected with a small loss because the land is flat.

Thus, when the recording face of the CD card body 1 is irradiated with the laser beam, a quantity of the reflected light varies depending on the positional relationship between the pits and the land. Thus, by irradiating the recording face of the CD card body 1 with the laser beam and detecting a quantity of the reflected light, data on the CD card body 1 represented by the pits and land can be read out.

In the additionally writing area 114, data can be additionally written. In the present embodiment, the additionally writing area 114 has a composition similar to that of the CD-R (Compact Disc-Recordable) as an example.

Formed on the additionally writing area 114 are recording tracks and sectors like the read only area 113. A dyestuff layer is provided on the side of the recording face side of the reflective layer in the CD card body 1. The dyestuff layer is irradiated with a laser beam having power higher than a predetermined value to change in quality to thereby form an area of a lower reflectance similar to that of the pit.

Thus, by irradiating the additionally writing area 114 with such a laser beam, pseudo pits and lands are formed. Thus, digital data represented by the pseudo pits and lands are recorded.

As shown in FIG. 21, the CD card body 1 is not square, but rectangular. Thus, when the respective diameters of the recording tracks on the additionally writing area 114 are larger than a shorter side of the rectangular CD card body 1, those recording tracks loose parts of the related circles to become respective pair of arcuate areas.

FIG. 22 illustrates a composition of recording tracks and sectors on the CD card 10 of FIG. 21. As shown in FIG. 22, a plurality of recording tracks is disposed concentrically on the CD card and divided into sectors. In FIG. 22, particular recording tracks and sectors are illustrated in an enlarged size for explanation's sake.

A recording track 113a schematically illustrates the outermost recording track of the read only area 113. Recording tracks 114a and 114b are formed on the additionally writing area 114.

The read only area 113 is positioned within the confines of the card 10. Thus, the respective recording tracks in the read only area 113 each take the form of a complete circle like the recording track 113a.

The additionally writing area 114 is positioned outside the read only area 113. Thus, each recording track in the additionally writing area has a larger diameter than the shorter side of the rectangular CD card body 1. Thus, the recording tracks on the additionally writing area 114 each do not form a circle, but a pair of arcuate ones.

For example, the arcuate recording tracks 114a and 114b of FIG. 22 are at equal distances from the hole 111. They are obtained by restricting or cutting completely circular recording tracks with shorter sides of the rectangular CD card body 1.

The CD card 10, thus constructed, is easily obtained by forming a disc having the read only area 113 and additionally writing area 114 in accordance with the general CD standards (a 12 cm diameter) or 8-cm standards, and then stamping out the disc into a rectangle.

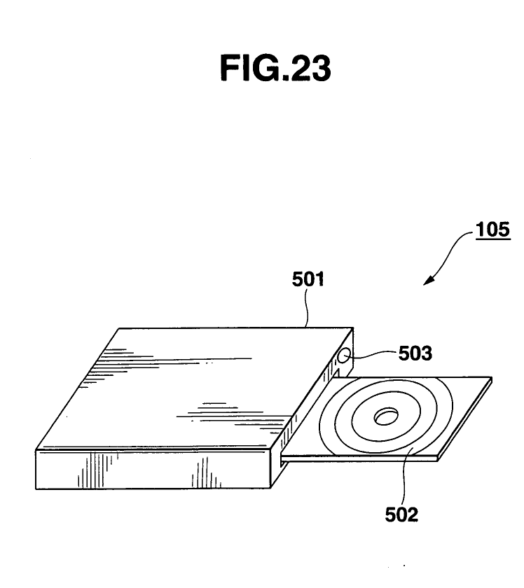

FIG. 23 is a perspective view of a drive device 105 in a second embodiment of the present invention. As shown in FIG. 23, the drive device 105 has a box-like housing 501 within which the components thereof are received. The drive device 105 has a slot on its front through which a tray 502 on which a CD card 10 is placed is movable into/out of the housing 501. The drive device 105 also has on its front a switch 503.

The switch 503 instructs the drive device to move the tray 502 into/ out of the housing. When a CD card 10 is placed on the tray 502 and the switch 503 is operated, the tray 502 is drawn into the housing 501. Thus, the drive device 105 reads/writes data from/into the CD card 10.

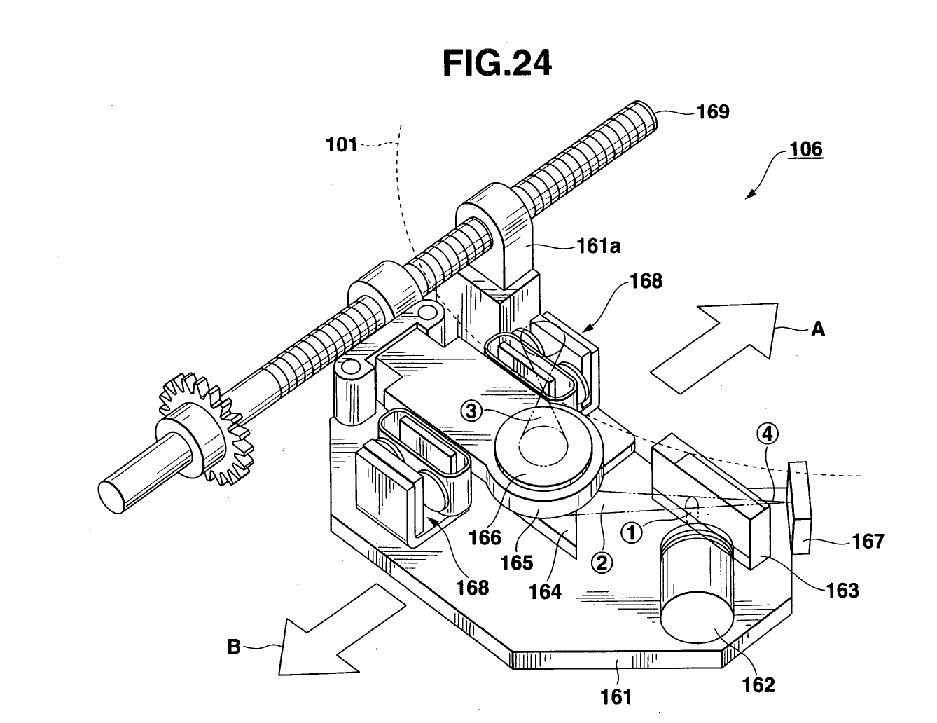

FIG. 24 illustrates a composition of a pickup 106 disposed within the drive device 105 of FIG. 23. The pickup 106 irradiates the CD card 10 with a laser beam and detects reflected light from the CD card 10.

A shown in FIG. 24, the pickup 106 comprises on a base 161, a semiconductor laser 162, a beam splitter 163, a mirror 164, a lens base 165 which supports a lens 166, a photosensor 167, and a pair of drive coils 168 with the base 161 being supported by a base moving shaft 169.

The base moving shaft 169 takes the form of a male-screwed rod. A pair of spaced upstanding arms 161a are provided near an end of the base 161 so as to receive the male-screwed moving shaft 169 in their female-screwed holes in engaging relationship.

When the base moving shaft 169 rotates, the pair of arms 161a moves along the male-screwed shaft 169. Thus, the base 161 moves in a direction indicated by A or B in FIG. 24. The base moving shaft 169 is rotated by a slider motor 504 to be described later further.

The semiconductor laser 162 outputs to a beam splitter 163 a laser beam \mathring{1} generated by a built-in light source under control of the controller 151.

The output value of the laser beam \mathring{1} output from the semiconductor laser 162 can be selected as required, for example, so that data recorded on the CD card 10 may be read or the output value of the beam can be increased so that data may be written into the additionally writing area 114 of the CD card 10.

The beam splitter 163 reflects the laser beam \mathring{1} output from the laser 162 as a laser beam \mathring{2} toward the mirror 164. When a beam \mathring{4} reflected by the recording face of the CD card 10 and also by the mirror 164 enters the beam splitter 163, the beam splitter 163 causes the reflected beam \mathring{4} to pass through the beam splitter toward a photosensor 167.

The mirror 164 reflects the laser beam \mathring{2} coming in a horizontal direction from the beam splitter 163 up toward the lens 166. The mirror 164 reflects a beam reflected by the recording face of the CD card 10 toward the beam splitter 163.

The lens 166 is fixed to the lens base 165 and irradiates the recording face of the CD card 10 with the laser beam \mathring{3} coming from the mirror 164. The laser beam \mathring{3} is focused on the recording tracks on the recording face of the CD card 10.

The photosensor 167 senses a quantity of the reflected light beam \mathring{4} coming through the beam splitter 163. The lens base 165 supports the lens 166 received therein in a fitting manner and is supported by the pair of drive coils 168 provided in an upstanding manner on the base 161. The pair of drive coils 168 are each disposed on a respective one of both sides of the lens base 165 to support the lens base 165 movable horizontally and vertically.

When the focal position of the lens 166 deviates in a horizontal direction from a recording track on the recording face of the CD card 10, the pair of drive coils 168 moves the lens base 165 in a horizontal direction so that the focal point of the lens 166 is on the recording track. When the focal point of the laser beam \mathring{3} deviates upward or downward so that complete focusing cannot be attained, for example, due to a bend of the CD card 10, the pair of drive coils 168 moves the lens base 165 vertically so that the lens is focused on the recording track.

As described above, in the pickup 106 the laser beam \mathring{1} produced by the semiconductor laser 162 enters the lens 166 via the beam splitter 163 and mirror 164. Thus, the laser beam \mathring{3} is applied from the lens 166 up toward the recording tracks on the CD card recording face.

The laser beam \mathring{3} reflected by the card recording face enters the photosensor 167 via the lens 166, mirror 164 and beam splitter 163. The photosensor 167 detects a quantity of the reflected beam \mathring{4} to read data recorded on the CD card 10.

By irradiating the additionally writing area 114 of the CD card 10 with the laser beam \mathring{3} that comprises an increased output value of the laser beam \mathring{1} output from the semiconductor laser 162, data is written to the CD card 10.

The pickup 106 is movable in the direction A or B in FIG. 24 by the operation of the base moving shaft 169. Thus, all the recording tracks on the CD card 10 are accessible to read/write data.

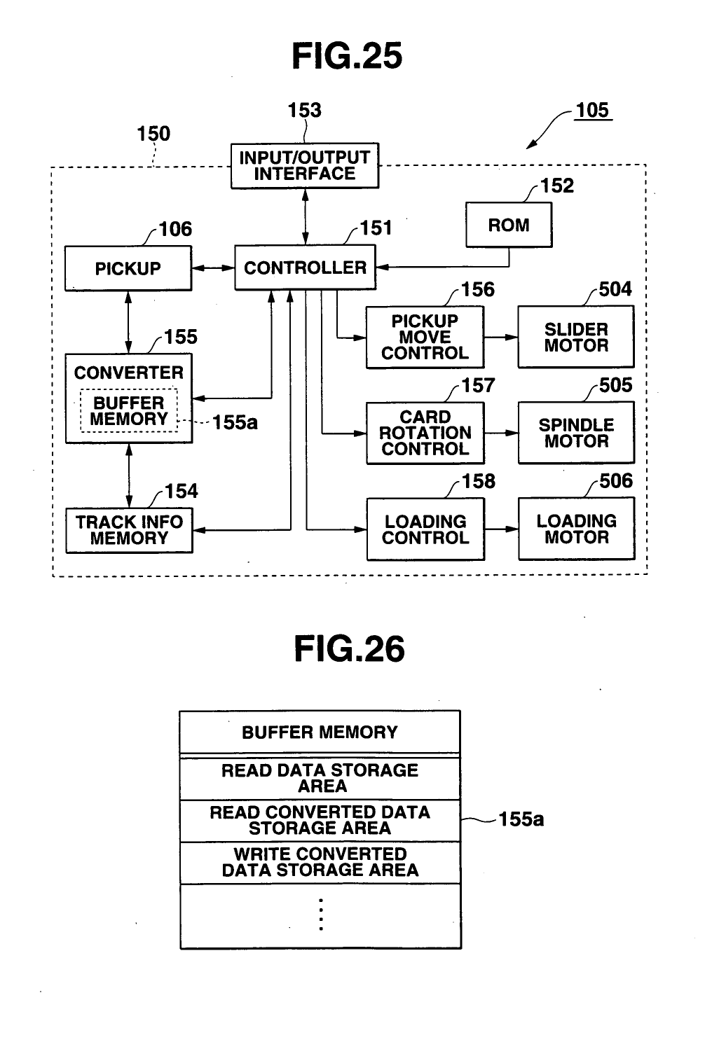

FIG. 25 is a block diagram of a controller 150 provided within the drive device 105. The control system 150 includes a ROM (Read Only Memory) 152, a input/output interface 153, a recording track information memory 154, a converter 155, a pickup move control unit 156, a card rotation control unit 157, and a loading control unit 158.

For explanation's sake, FIG. 25 shows the pickup 106; and a slider motor 504, spindle motor 505 and a loading motor 506 of the drive device 105.

The control system 150 is connected via the input/output interface 153 to an external electronic device (not shown), which comprises a personal computer or a PDA (Personal Digital Assistant), for example. The control system 150 operates in accordance with an instruction inputted by the external electronic device, outputs data, read from the CD card 10, via the input/output interface 153, and records data input via the input/output interface 153 to the CD card 10.

The controller 151 reads various system programs stored in ROM 152 and executes them to control the respective components of the control system 150. More specifically, when the switch 503 (FIG. 23) is operated in a state where the tray 502 (FIG. 23) is outside the housing 501, the controller 151 moves the tray 502 into the housing 501, and determines if there is the CD card 10 on the tray 502. If there is, the controller 151 drives the loading motor 506 to load the CD card 10.

Then, in accordance with instructions given via the input/output interface 153, the controller 151 reads/writes data from/into the loaded CD card 10.

ROM 52 includes a semiconductor memory such as an EPROM, EEPROM or flash memory, which has stored programs to be executed by the controller 151 and data on the system programs.

The input/output interface 153 includes a serial or parallel interface that connects the controller 151 and the external electronic device, and has a connector with a plurality of connection pins.

The recording track information memory 154 has a storage area that has stored data representing a composition of recording tracks and sectors of the CD card 10 among the data to be read out by the pickup 106.

The converter 155 converts data read by the pickup 106 to another data. For example, the converter converts a serial signal to a parallel signal of a predetermined bit width. The converted signal is then output to the controller 151. The converter 155 includes a buffer memory 155a in which data under conversion and data received from the pickup 106 are stored temporarily.

FIG. 26 illustrates one example of a composition of the buffer memory 155a. As shown, the buffer memory 155a includes a read data storage area which stores data read by the pickup 106, a read converted data storage area which temporarily stores data obtained by converting the data, stored in the read data storage area, with the converter 155, a write converted data storage area for temporarily storing the data converted by the converter 155 to write the data through the pickup 106 to the additionally writing area 114 of the CD card 10, etc. Thus, data reading and additional writing operation by the drive device 105 is stabilized.

A pickup move control unit 156 is connected to a slider motor 504 so that the slider motor 504 is controlled by the controller 151 to translate the base 161 of the pickup 106 (FIG. 24).

The card rotation control unit 157 is connected to a spindle motor 505 so that the spindle motor 505 is driven by the controller 151 to rotate the CD card 10 placed on the tray 502.

A loading control unit 158 is connected to a loading motor 506 so that the loading motor 506 is controlled by the controller 151 to move the tray 502 (FIG. 23) to perform a loading operation which includes moving the CD card 10 placed on the tray 502 to a position where the data can be read/written from/to the CD card.

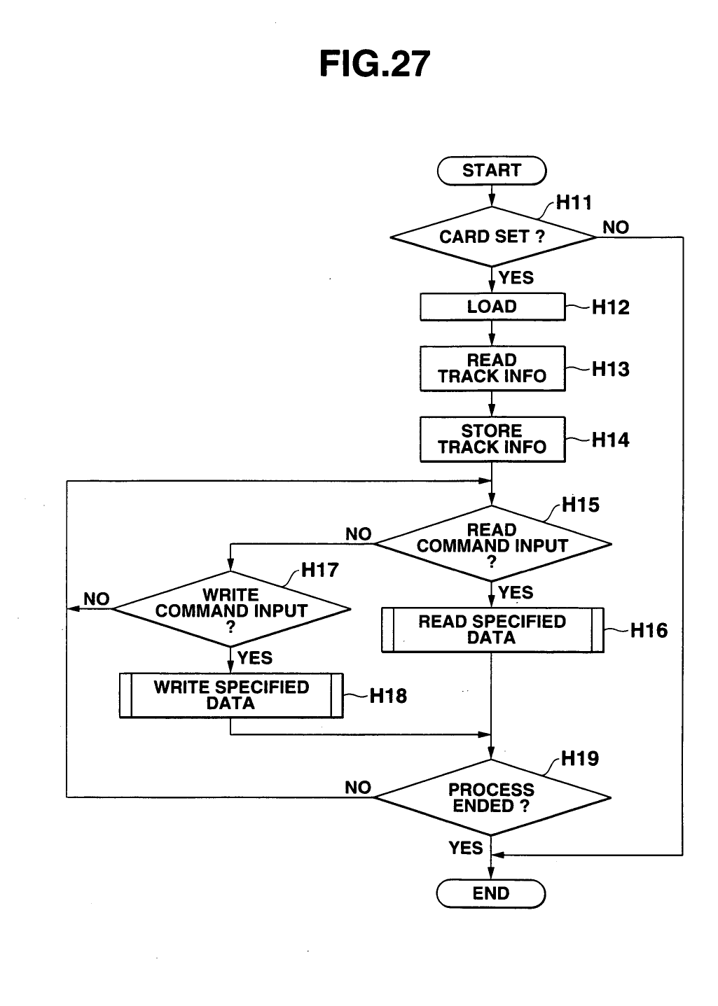

FIG. 27 is a flowchart of operation of the drive device 105 in a second embodiment. When the switch 503 (FIG. 23) on the drive device 105 is operated to move the tray 502 into the hosing 501, the controller 151 determines if a CD card 10 is placed on the tray 502 (step H11). If otherwise, the controller 151 terminates this process. If it is, the controller 151 controls the loading control unit 158 to cause the loading motor 506 to perform the loading operation that includes moving the CD card 10 to a position where data can be read/written (step H12).

Subsequently, the controller 151 controls the card rotation control unit 157 to drive the loading motor 506 to thereby cause the pickup 106 to read data on the composition of the recording tracks and sectors on the CD card 10 among the various data recorded on the CD card 10 (step H13) and to store the data in the recording track information memory 154 (step H14).

Then, the controller 151 waits until the controller 151 receives a command to read/write data from/into the CD card 10 from the external electronic device via the input/output interface 153 (steps H15, 17).

When the controller 151 receives the command to read data on the CD card (step H15, Yes), the controller 151 reads data recorded on the read only area 113 or the additionally writing area 114 of the card 10 (step H16).

When the controller 151 receives the command to write data to the CD card (step H16, Yes), the controller 151 writes data to the additionally writing area 115 of the card 10 (step H18).

Then, the controller 151 determines if the processing on the loaded CD card 10 has been completed (step H19). If otherwise, the controller 151 returns the control to step H15.

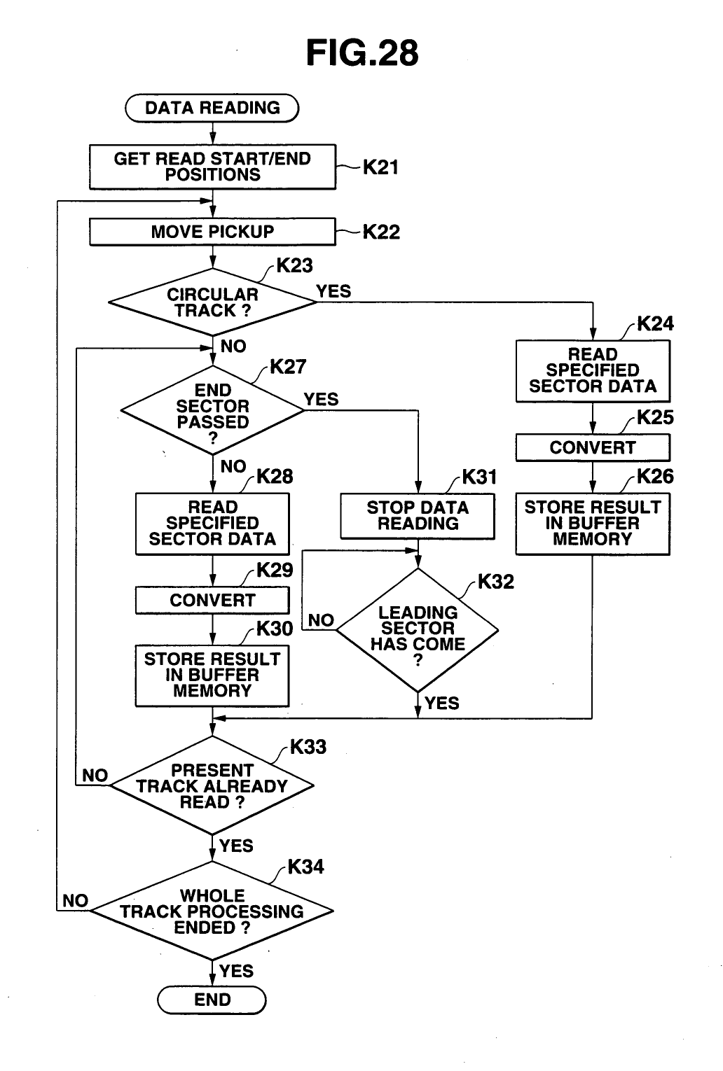

FIG. 28 is a more detailed flowchart of the data reading process shown in step H16 of FIG. 27. The controller 151 acquires data on the positions where data reading starts and ends on the CD card 10 in accordance with a command of data reading input by the external electronic device via the input/output interface 153 (step K21). That is, the controller 151 specifies recording tracks and sectors on the CD card 10 where data should be read and the order of sectors from which data should be read, based on the information stored in the recorded track information memory 154.

Subsequently, the controller 151 controls the pickup move control unit 156 to drive the slider motor 504 to thereby move the pickup 106 to the recording track where data should first be read (step K22).

The controller 151 then controls the card rotation control unit 157 to drive the spindle motor 505 to thereby rotate the CD card 10 to cause the pickup 106 to irradiate the target recording track with a laser beam, and to sense a sensing quantity of the photosensor 167. The controller 151 then determines based on the sensing quantity if the target recording track is a complete circle (step K23). Note that the “complete circle” in this specification implies a literally complete circle as well as a spiral, as mentioned above.

When the target recording track takes the form of a “complete circle”, in the pickup 106 the recording face of the CD card 10 is irradiated with a light beam output from the lens 166 and reflects most of the light beam with the recording face. Thus, a quantity of light sensed by the photosensor 167 is within a predetermined range. If the target recording track does not take the form of a “complete circle”, the laser bean from the semiconductor laser 162 can deviate instantaneously from the CD card 10 and hence a quantity of light sensed by the photosensor 167 becomes close to 0 at that time. Thus, the controller can determine depending on the quantity of the reflected light \mathring{4} (FIG. 24) sensed by the photosensor 167 if the target recording track takes the form of a “complete circle”.

When the target recording track takes the form of a complete circle (step K23; Yes), the controller 151 causes the pickup 106 to read data on the specified sector of the target track (step K24), to cause the converter 155 to convert the read data (step K25), and to store resulting data in the buffer memory 155a (step K26). Step K33 is next.

When the target recording track dose not take the form of a complete circle (step K23; No), the controller 151 specifies a sector placed above the lens 166 in the pickup 106, and then determines if an end sector has passed (step K27). If otherwise, it is meant that the recording face of the CD card 10 is placed above the lens 166. If the end sector has passed, it is known that the CD card 10 is not placed above the lens 66.

Thus, before the end sector has passed (step K27; No), the pickup 106 reads data on the specified sector (step K28), the converter 155 converts the read data (step K29) and stores the converted data in the buffer memory 155a (step K30). Step K33 is next.

When the end sector has passed over the lens 166 (step K7; Yes), the controller 151 causes the pickup 106 to stop data reading (step K31), and then waits until the leading sector comes to over the lens 66 (step K32).

The leading sector is positioned at a first appearing end of the non-circular recording track in the vicinity of a related end of the CD card 10. When data from the non-circular recording track is read through the lens 166, there occur alternately a state where the laser beam \mathring{3} (FIG. 24) from the lens 166 is reflected by the CD card 10 and a state where the laser beam \mathring{3} is not reflected because there is no CD card 10 above the lens 166. From the moment the leading sector is placed above the lens 66 to the moment the end sector is placed above the lens 166, the laser beam \mathring{3} is reflected by the CD card 10 and data is read out.

When the controller 151 determines in step K32 that the leading sector has come to above the lens, step K33 is next, where the controller 151 determines if reading on the recording track placed at present above the lens 166 is all completed. If otherwise, the controller returns the control to step K27. If it is, step K34 is next.

In step K34 the controller 151 determines if the processing on all the recording tracks on the CD card 10 has been completed. If the controller 151 should continue to read data on the CD card 10, it returns the control to step K22 where the controller 151 moves the pickup 106 to a position of the next target recording track and then continues the processing.

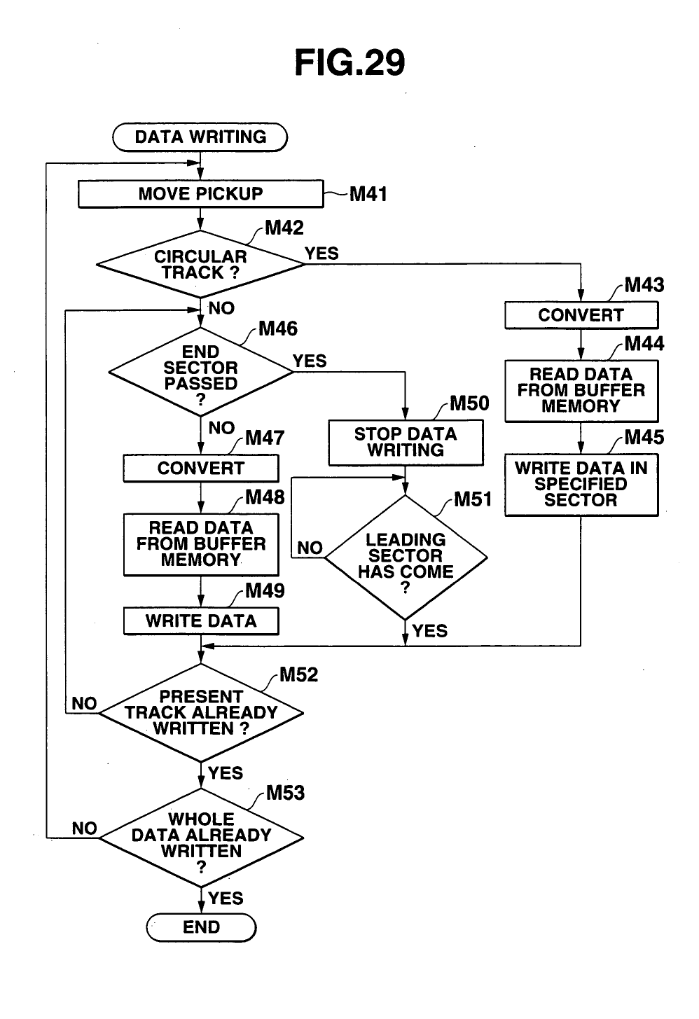

FIG. 29 is a more detailed flowchart of the data writing process in step H18 of FIG. 27. The controller 151 specifies the leading recording track and sector of a data writable area of the CD card 10 in accordance with a command of data writing input by the external electronic device through the input/output interface 153, and controls the pickup move control unit 156 to drive the slider motor 504 to thereby move the pickup 106 (step M41).

Subsequently, controller 151 controls the rotation control unit 157 to drive the spindle motor 505 to thereby rotate the CD card 10, to cause the pickup 106 to irradiate a target recording track with a laser beam, and to determine if the target recording track takes the form of a complete circle based on the sensing quantity of the photosensor 167 (step M42).

When the target recording track takes the form of a complete circle (step M42; Yes), the controller 151 causes the converter 155 to convert the write data input by the external electronic device, and then stores resulting data in the buffer memory 155a (step M43).

Subsequently, controller 151 reads data from the buffer memory 155a (step M44), and then causes the pickup 106 to write data to a specified sector (step M45). Step M52 is next.

When the target recording track dose not take the form of a complete circle (step M42; No), the controller 151 specifies a sector placed on the lens 166 of the pickup 106 and then determines if the end sector has passed over the lens 66 (step M46).

When the end sector has not yet passed (step M46; No), the controller 151 causes the converter 155 to convert the write data input by the external electronic device, and then stores resulting data in the buffer memory 155a (step M47).

The controller 151 then reads the converted data stored in the buffer memory 155a (step M48), and then causes the pickup 106 to write data to the additionally writing area 114 of the CD card 10 (step M49). Step M52 is next.

When the end sector has already passed above the lens 66 (step M46; Yes), the controller 151 causes the pickup 106 to stop writing data (step M50), and then waits until the leading sector comes to above the lens 166 (step M51). When the controller 151 determines that the leading sector has come over the lens, step M52 is next. In step M52, the controller 151 determines if data writing on the recording track placed at present on the lens 166 is all completed. If otherwise, the controller returns the control to step M46. If it is, step M53 is next.

In step M53, the controller 151 determines if the processing on all the recording tracks of the CD card 10 has been completed. If the controller should continue to write data on the CD card 10, it returns the control to step M41.

As described above in the second embodiment, the CD card 10 has the read only area 113 and the additionally writing area 114. Thus, the drive device 105 reads data recorded on the read only area 113 and writes new data to the additionally writing area 114, from which the data can be read out like the data recorded in the read only area 113.

Since the CD card 10 takes substantially the form of a rectangle, it can be easily received in any one of various cases, bags and pockets of clothes and is suitable for carrying. It can take the form of a credit card or visiting card used generally so as to reduce its weight when it is carried.

The read only area 113 and the additionally writing area 114 of the CD card 10 have a similar composition to that of the CD-ROM, CD-R or other recording mediums. Thus, the CD card 10 ensuring high reliability is provided at a low cost.

Since the read only area 113 and the additionally writing area 114 of the CD card 10 are disposed concentrically, they can be rotated by the drive device 105 for data reading like the conventional disc-like recording mediums such as CDs and DVDs. Thus, the drive device 105 that reads/writes data from/into the CD card 10 is provided at low cost. If the CD card 10 has compatibility with the conventional disc-like recording mediums, the drive device 105 is manufactured at a very low cost.

Since the CD card 10 has the optically readable read only area 113 and an additionally writing area 114, it can greatly increase the recording capacities of the areas 113 and 114. Thus, the CD card 10 is excellent in portability and convenience and usable as a recording medium having a large capacity.

When the drive device 105 reads/writes data from/to the CD card 10, it determines if the target recording track is circular or not. Even when the target track is not completely circular, the drive device 105 can write and read data. Thus, the read only area 113 and additionally writing area 114 can be provided on areas of the CD card 10 where no circular recording tracks can be formed on the CD card 10. Thus, data can be recorded on substantially all the recording face of the CD card 10. Thus, the CD card 10 is usable as a recording medium having a large capacity.

Since the drive device 105 detects the presence of a CD card 10 above the lens 166 based on a quantity of reflected light \mathring{4} sensed by the photosensor 167. Thus, non-circular recording track portions of the CD card 10 can be detected easily and correctly. Thus, data can rapidly be read/written from/to the CD card 10.

While in the second embodiment the CD card 10 is illustrated as having the shape of a rectangle, the card is not limited to the particular shape in the present invention. The shapes of the CD cards including a polygon are not important. While the CD card 10 is illustrated as having a read only area 113 of circular recording tracks and an additionally writing area 114 formed outside the area 113, the areas 113 and 114 may be reversed in position.

While the pickup 106 is illustrated having the composition where the presence of the CD card 10 above the lens 166 is detected depending on the quantity of reflected light \mathring{4} sensed by the photosensor 167, the present invention is not limited to this particular composition. For example, if information on the composition of the recording tracks, the sectors and their shapes is recorded at a predetermined position on the CD card 10 and then stored in the recording track information memory 154, the controller 151 can obtain data on the relationship between the shapes of the CD cards 10 and the positions of their sectors. In this case, the shapes of the CD cards 10 need not be sensed sequentially by the photosensor 167, and required processing can be performed rapidly.

The widths and intervals of the recording tracks on the CD card 10 are not limited to the CD standards. For example, the intervals of the recording tracks may further increase to facilitate writing and reading data in the additionally writing area 114 having non-circular recording tracks.

While in steps K23 and M42 of FIGS. 28 and 29, respectively, the controller 151 is illustrated as determining if the target recording track on the CD card 10 is circular based on the quantity of light sensed by the photosensor 167 of the pickup 106, the pickup 106 may have a photosensor that determines if the target track is circular.

While in the CD card 10 of the embodiment the additionally writing area 114 is illustrated as being writable like a CD-R, it may have a phase change type recording layer like a CD-RW (Compact Disc ReWritable) or a PD (Phase change writable Disc) or MO (Magneto-Optic) disc so that data can be written or erased many times.

The read only area 113 may have a composition similar to that of the DVD-ROM. Also, the additionally writing area 114 may have a composition similar to that of a DVD-R, DVD+RW or DVD-RAM to ensure an increased memory capacity. The details of other structural portions of the CD card may be changeable as requested, of curse.

(Modification)

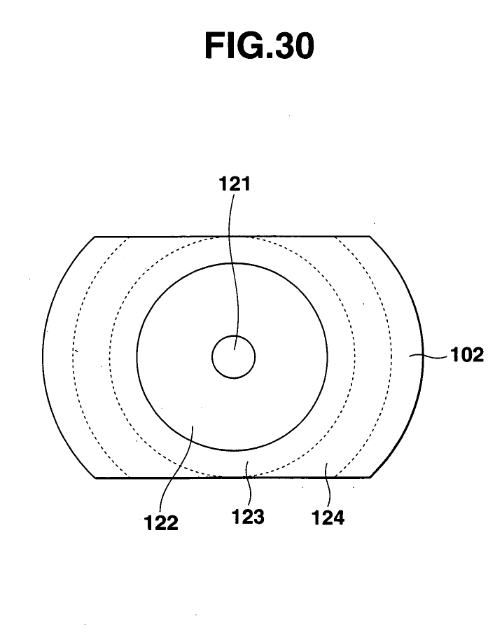

A modification of the second embodiment will be described next. FIG. 30 is a perspective view of a CD card 102 as the modification. Like the CD card 10 of the second embodiment, the CD card 102 comprises a non-circular recording medium that includes a circular transparent plastic support disc 122 having a central circular hole 121, a ring-like read only area 123 concentric with the support disc 122, and a non-circular additionally writing area 124 concentric with the support disc 122 outside the read only area 123.

The CD card 102 takes a modification of the rectangular CD card 10 (FIG. 21) whose shorter sides are replaced with corresponding arcs. That is, the CD card 102 has the form obtained by cutting away a disc along a pair of parallel straight lines symmetrical with reference to the center of the circle, or defined by the pair of straight line segments and a pair of corresponding arcuate segments.

That is, the inventive non-circular recording medium may not have a rectangular shape like the CD card 10. The non-circular recording medium may have a shape surrounded by a pair of parallel straight-line segments, and a pair of curved line segments, like the CD card 102. The CD card 102 can be manufactured easily at low cost by cutting a circular recording track medium disc, as mentioned above.

In the CD card 102 the read only area 123 corresponds to the read only area 113 of the CD card 10 whereas the additionally writing area 124 of the CD card 102 corresponds to that 114 of the CD card 10. Thus, the CD card 102 produces advantageous effects similar to those produced by the CD card 10 in the second embodiment.

If the CD card 102 is shaped so that its outermost arcuate edges coincide with parts of the periphery of a disc conforming to the conventional CD standards, the CD card 102 is usable in general CD drive devices. In this case, the CD card 102 comprises a conventional CD whose contour parts are missing, so that the CD card 102 is usable set in a recess in the CD drive device in which the conventional CD fits to thereby read/write data from/to the CD card 102.

### Third Embodiment

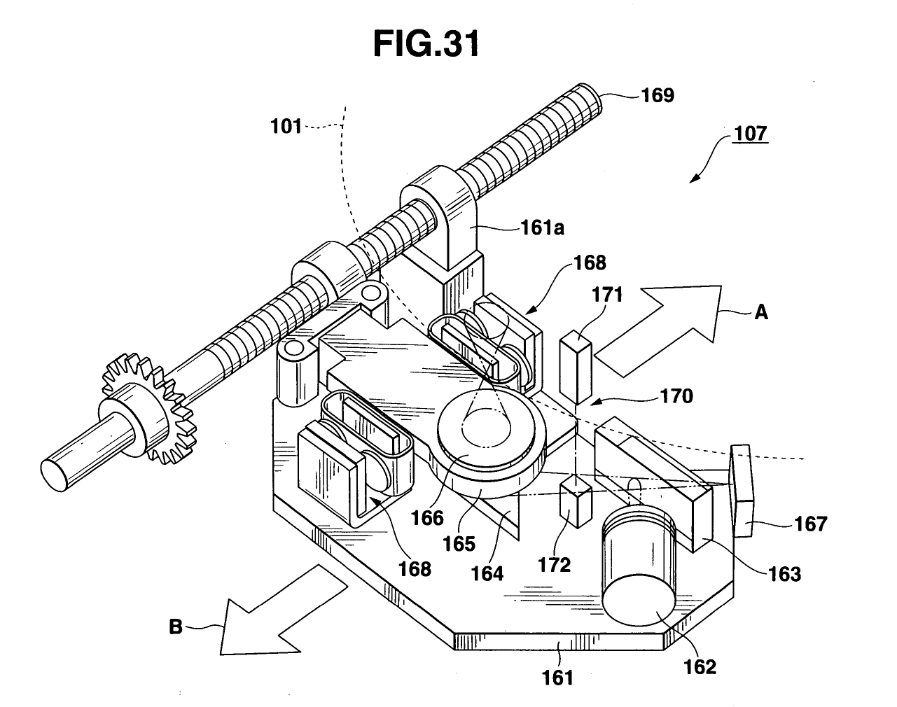

FIG. 31 is a perspective view of a pickup 107 in the third embodiment. The pickup 107 has a composition similar to that of the pickup 106 of the second embodiment. Thus, the same reference numeral is used to denote the same element in the second and third embodiments, and further description thereof will be omitted. In the third embodiment, the CD card 10 of the second embodiment is used. The drive device 105 of the third embodiment has the same composition as that of the second embodiment except for the pickup 7. Thus, the same reference numeral is used to denote the same component of the drive devices 105 and 106 of the second and third embodiments, and further description will be omitted.

The pickup 107 comprises a photosensor 170 that includes a light emitting unit 171 and a light sensing unit 172. The light sensing unit 172 is of an upstanding type provided on the base 161 to sense light from above. The light emitting unit 171 is disposed above the light sensing unit 172 to emit light toward the light sensing unit 172.

Thus, the photosensor 170 senses the presence of an object between the light emitting unit 171 and the light sensing unit 172, by sensing if the light output from the light emitting unit 171 is sensed by the light sensing unit 172.

The light emitting unit 171 and the light sensing unit 172 are respectively disposed above and below the recording track of the CD card 10 irradiated with a laser beam through the lens 166.

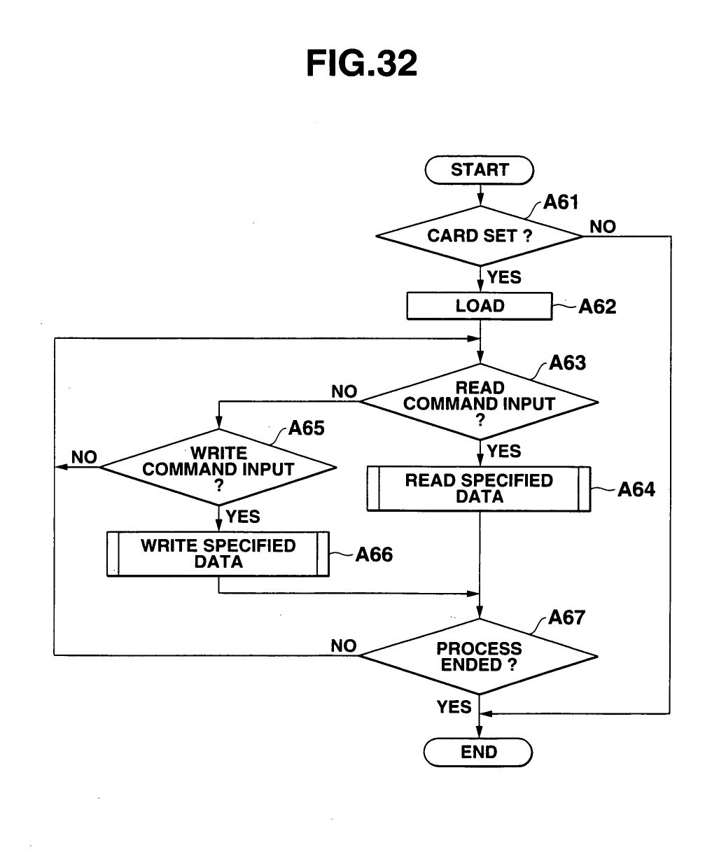

Operation of the drive device 105 that includes the pickup 107 will be described with reference to a flowchart of FIG. 32.

When the switch 503 (FIG. 23) on the drive device 105 is operated so that the tray 502 is moved into the housing 501, the controller 151 determines if a CD card 10 is placed on the tray 502 (step A61).

If otherwise, the controller 151 terminates this process. If it is, the controller 151 controls the loading control unit 158 to cause the loading motor 506 to perform a loading operation that includes moving the CD card 10 to a position where data is readable/writable from/to the CD card (step A62).

The controller 151 then waits until it is instructed by the external electronic device via the input/output interface 153 to read or write data from or to the CD card 10 (steps A63, A65).

When the controller 151 is instructed to read data from the CD card 10 (step A63; Yes), the controller 151 reads data recorded in the read only area 113 on the CD card 10 or in the additionally writing area 114 (step A64).

When the controller 151 is instructed to write data to the CD card 10 (step A65, Yes), the controller 151 writes data to the additionally writing area 114 on the CD card 10 (step A66).

Then, the controller 151 determines if the, processing on the loaded CD card 10 has been completed (step A67). If otherwise, the controller returns the control to step A63.

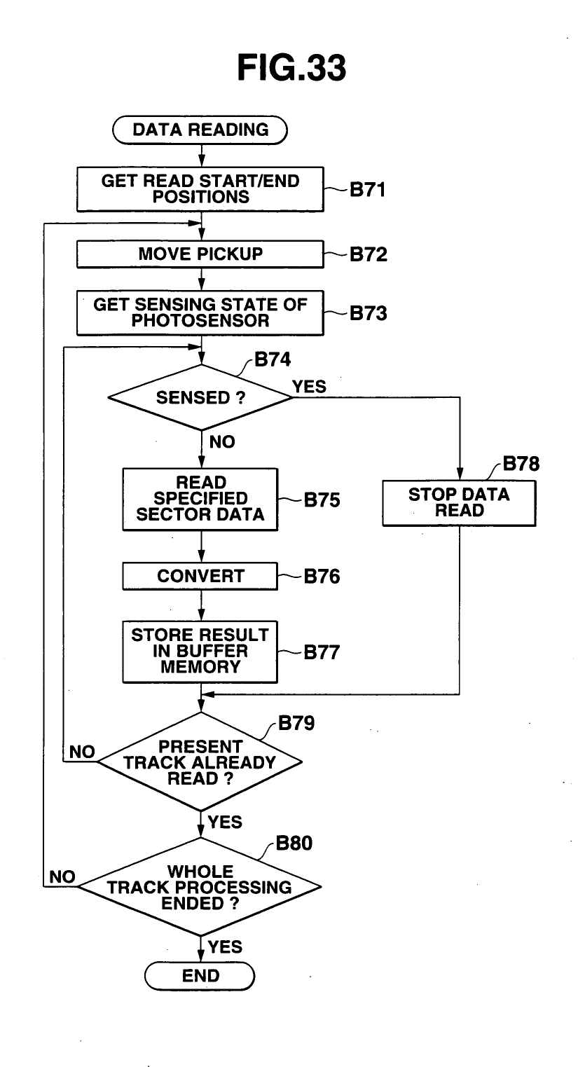

FIG. 33 is a more detailed flowchart of the data reading process in step A64 of FIG. 32. The controller 151 acquires information on positions where the controller starts and terminates the reading of data from the CD card 10 in accordance with a command of data reading input by the external electronic device via the input/output interface 153 (step B71). The controller 151 specifies a recording track and sectors of the CD card 10 where data should be read and determines the order of the sectors in which the data is read, based on the information stored in the recording track information memory 154.

Subsequently, the controller 151 controls the pickup move control unit 156 to drive the slider motor 504 to thereby move the pickup 107 to a position of a first target recording track where data should first be read (step B72).

The controller 151 controls the card rotation control unit 157 to drive the spindle motor 505 to thereby rotate the CD card 10, to cause the light emitting unit 171 of the photosensor 170 to irradiate the light sensing unit 172 with a light beam to thereby acquire a sensing state of the light sensing unit 172 (step B73).

The controller 151 then determines if the CD card 10 is positioned over the lens 166 based on the sensing state of the light sensing unit 172 (step B74).

When the light sensing unit 172 fails to sense a light beam from the light emitting unit 171 and hence senses the presence of the CD card 10 (step B74; No), the controller 151 causes data on the specified sector on the target recording track to be read (step B75), and to be stored temporarily in the buffer memory 155a.

The controller 151 causes the converter 155 to convert the read data (step B76), and stores resulting data in the buffer memory 55a (step B77). Step B80 is next.

When the light beam emitted by the light emitting unit 171 is sensed by the light sensing unit 172 and no CD card 10 is sensed above the lens 166 (step B74; Yes), the controller 151 stops data reading by the pickup 107 (step B78). Step B79 is next.

In step B79 the controller 151 determines if data reading about the recording track present at present over the lens 166 is all completed. If otherwise, the controller returns the control to step B74. If it is, step B80 is next.

In step B80 the controller 151 determines if the processing about all the recording tracks on the CD card 10 has been completed. If the data reading on the CD card 10 should-continue, the controller returns the control to step B72 to move the pickup 107 to the position of the next target recording track to thereby continue the data reading.

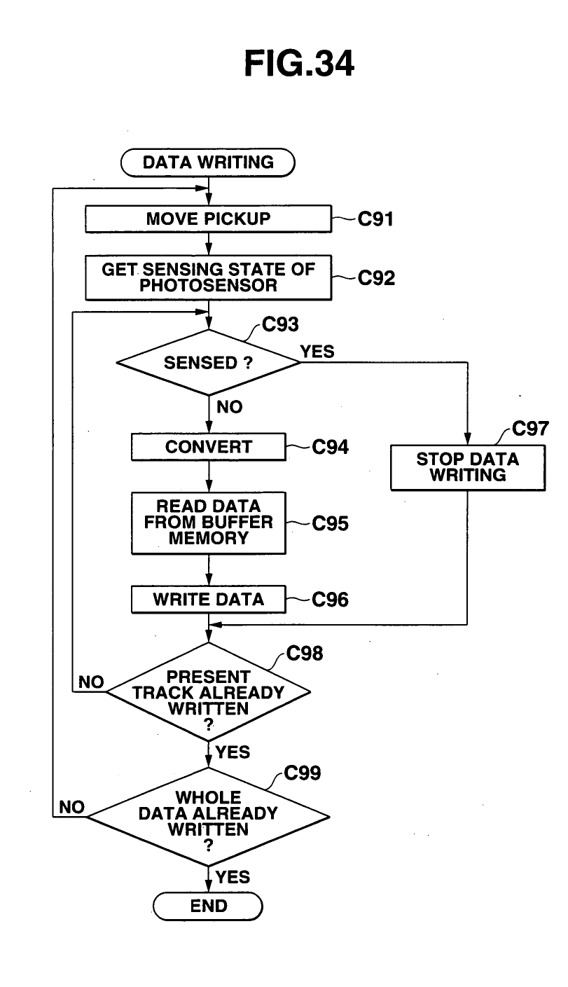

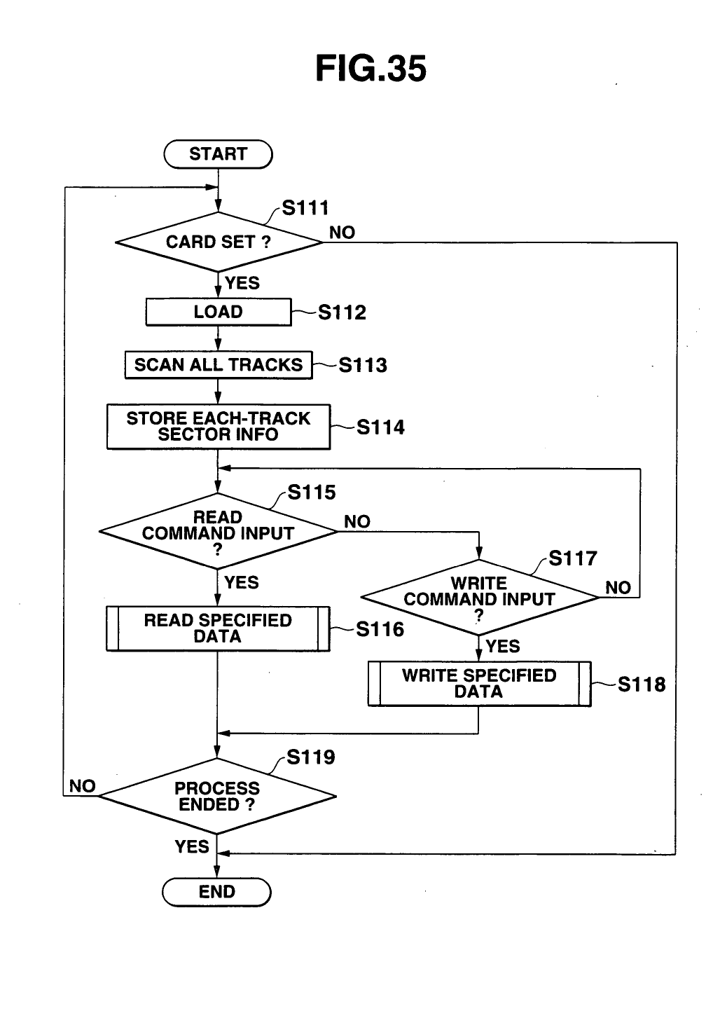

FIG. 34 shows a more detailed flowchart of the data writing process in step A66 of FIG. 32.

The controller 151 specifies a leading recording track and sector in the area of the CD card 10 where data is writable in accordance with a command of data writing input from the external electronic device via the input/output interface 153, and then controls the pickup move control unit 156 to drive the slider motor 504 to thereby move the pickup 107 to the specified recording track and sector (step C91).

The controller 151 then controls the card rotation control unit 157 to drive the spindle motor 505 thereby to rotate the CD card 16, causes the light emitting unit 171 of the photosensor 170 to irradiate the light sensing unit 172 with a light beam to obtain a sensing state of the sensing unit 172 (step C92).

The controller 151 determines if the CD card 10 is positioned above the lens 166 based on the sensing state of the sensing unit 172 (step C93).

When the light sensing unit 172 fails to sense the light beam from the light emitting unit 171 to thereby sense the CD card 10 (step C93, No), the controller 151 causes the converter 155 to convert the write data input by the external electronic device to required data, and stores this data in the buffer memory 55a (step C94).

Subsequently, the controller 151 reads data from the buffer memory 155a (step C95), and then causes the pickup 107 to write data in a specified sector (step C96). Step C99 is next.

When the light beam emitted by the light emitting unit 171 is sensed by the light sensing unit 172 and no CD card 10 is detected above the lens 166 (step B74; Yes), the controller 151 stops data writing by the pickup 107 (step C97). Step C98 is next.

In step C98 the controller 151 determines if data writing on the recording track positioned at present above the lens 166 is all completed. If otherwise, the controller returns the control to step C93. If it is, step C99 is next.

In step C99 the controller 151 determines if the processing on all the recording tracks of the CD card has been completed. If data writing on the CD card 10 should continue, the controller 151 returns the control to step C91.

As described above, according to the third embodiment, the pickup 107 of the drive device 105 senses the presence/absence of the CD card 10, using the photosensor 170. When the CD card 10 is not above the lens 166, the controller 151 stops reading/writing data from/to the CD card 10.

Thus, the drive device 105 performs similar processes on a completely circular recording track and a circular recording track of the CD card 10 whose parts are missing, and stops or reopens the processing rapidly depending on a result of sensing by the photosensor 170. Thus, the shapes of the recording tracks on the CD card 10 need not be examined beforehand and data can be read/written from/to the CD card 10. The drive device 105 can rapidly adapt to a non-circular recording track. Thus, the disposition of the recording tracks on the CD card 10 is not limited and hence the recording face of the CD card 10 can be effectively utilized to thereby give the CD card a large recording capacity.

While in the third embodiment the shape of the recording tracks on the CD card is illustrated as being not specially limited, a mark may be put on a sector of the CD card 10 adjacent to its end to discriminate that sector from others. In this case, the photosensor 170 can acquire data on the position of the mark on the CD card 10 above the lens 166 and not the presence/absence of the CD card 10 above the lens 66. Thus, the rotational state of the CD card 10 is known.

### Fourth Embodiment

A fourth embodiment of the present invention will be described. In this embodiment, the CD card 10, drive device 105 and its pickup 106 are the same in composition as the corresponding components of the third embodiment. Thus, the same reference numeral is used to denote the same component of the fourth and third embodiments, and further description thereof will be omitted.

When the switch 503 (FIG. 23) of the drive device 105 is operated to move the tray 502 into the housing 501, the controller 151 determines if a CD card 10 is placed on the stray 502 (step S111).

If no CD card 10 is placed on the tray, the controller 151 terminates this process. If the CD card 10 is placed on the tray 502, the controller 151 controls the loading control unit 158 to cause the loading motor 506 to perform a loading operation to thereby move the CD card 10 to a position where data is readable or writable from or to the CD card (step S112).

Subsequently, the controller 151 causes the card rotational control unit 157 to drive the spindle motor 505 and causes the pickup move control unit 156 to drive the slider motor 504 to thereby acquire information on the shapes of all the recording tracks and the positions of all the sectors on the CD card 10 (step S113).

In step S113, for example, the controller 151 may determine if the recording tracks of the CD card 10 are above the lens 166 based on a quantity of the reflection \mathring{4} sensed by the photosensor 167 of the pickup 106 to thereby sense the shape of each of the recording tracks on the CD card 10, or may sense the shape of the CD card 10 with the photosensor 170 of the pickup 107 of the third embodiment.

The controller 151 then stores the information acquired in step S113 into the recording track information memory 154 (step S114).

The controller 151 then waits until it is instructed to read or write data from or to the CD card 10 by the external electronic device via the input/output interface 153 (steps S115, S117).

When the controller 151 is instructed to read data on the CD card 10 (step S115; Yes), the controller 151 reads data recorded on the read only area 113 or additionally writing area 114 on the CD card 10 (step S116).

When the controller 151 is instructed to write data to the CD card 10 (step S116, Yes), the controller 151 writes data to the additionally writing area 114 on the CD card 10 (step S118).

Then, the controller 151 determines if the processing on the loaded CD card 10 has been completed (step S119). If otherwise, the controller returns the control to step S111.

The processing performed in steps S116 and S118 may be similar to the data reading and writing processes (FIGS. 28 and 29), respectively, in the third embodiment.

As described above, according to the fourth embodiment the controller 151 acquires information on the shapes of all the recording tracks and the positions of all the sectors of the CD card before data is read or written from or to the CD card 10. Thus, data can be read/written rapidly and efficiently.

That is, it is unnecessary to determine if the target recording track is circular or not and if the CD card is present above the lens 166 each time data is read/written. Thus, the processing on a plurality of recording tracks and sectors can be performed efficiently.

While in the first-fourth embodiments and the modification of the second embodiment the CD card 10 that comprises a rectangular non-circular recording medium and the CD card 102 that comprises a non-circular optical recording medium defined by a pair of parallel upper and lower sides and a pair of right and left arcuate sides have been illustrated, the present invention is not limited to these particular cases. The present invention may be applicable to, for example, lozenge-shaped or trapezoidal, non-circular optical recording mediums easy to handle or carry.

### Fifth Embodiment

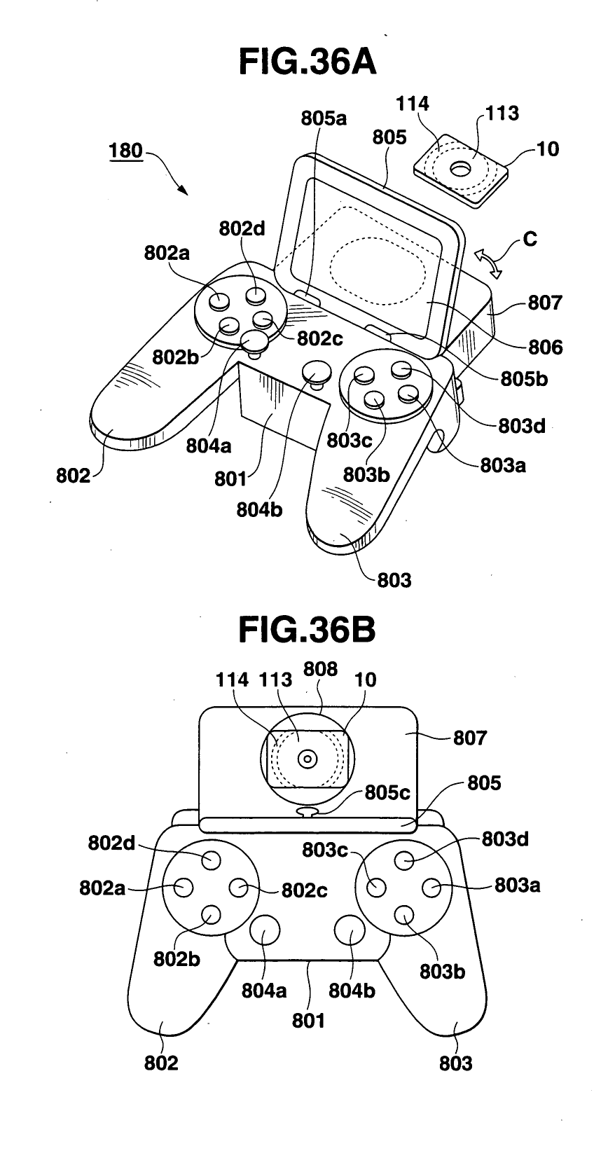

FIGS. 36A and B show a fifth embodiment of the invention involving a game device 180. FIGS. 36A and B are a perspective view and a plan view of an essential portion of the game device, respectively.

FIG. 36A illustrates a recording medium driving device or controller 805 as the fifth embodiment before the CD card 10 is set in a tray 808 provided in the controller 805. FIG. 36B illustrates the controller 805 after the card is set in the tray.

As shown in FIGS. 36A and B, the game device 180 includes all the components of the control system 150 of FIG. 25 within the housing 801 thereof. The game device 180 also has various controller switches 802a, 802b, 802c, 802d and controller switches 803a, 803b, 803c, 803d, and joysticks 804a, 804b on a forward section thereof. The game device 180 also has a backward section 807 whose top constitutes the card tray 808, and a cover 805 that includes a liquid crystal panel 806 and supported turnable by a pair of hinges 805a and 805b at the border between the forward and backward sections.

The forward section of the game device 180 comprises a pair of forward protruding grips 802 and 803 grippable by a game player. When a CD card 10 is set on the tray 808 and the cover 805 is closed, the set CD card 10 is held on its either side by a cramp 805c provided on the back of the cover 805 and cramps (not shown) provided on the backward section 807 side.

The liquid crystal panel 806 displays the contents of a game. A game played by the game device 180 will be described next with reference to FIGS. 37A and 37B.

FIGS. 37A and B illustrate an internal composition of a CD card 10 in the fifth embodiment. FIG. 37A illustrates a composition of a read only area 113 of the card. FIG. 37B illustrates a composition of an additionally writing area 114 of the card.

As shown in FIG. 37A, the read only area 113 comprises a game program data area where a game program is stored, a game character image data area where image data such as game characters and a background to be used in a game is stored, a game music/voice data area where game music data is stored, etc.

Data recorded in the read only area 113 of FIG. 37A is already stored in the CD card 10 when shipped.

As shown in FIG. 37B, the additionally writing area 114 comprises a game result data area where a result of the game is recorded, a parameter recording area where parameters on a set state and progression of the game are recorded, a game start/end history data area where dates when the game starts/ends and game's history are recorded, a user input data area where a user can records any data, etc.

Therefore, various data are additionally recordable in the respective subareas of the additionally writing area 114 as the game progresses.

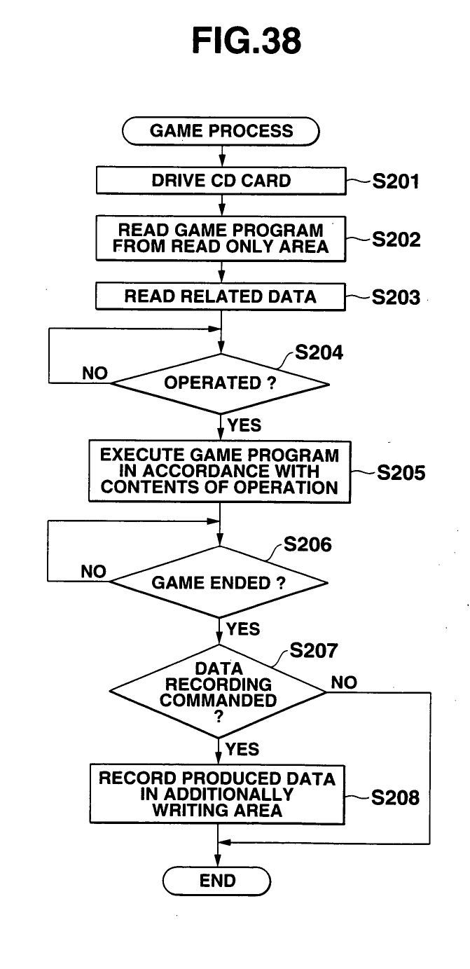

FIG. 38 is a flowchart of operation of the fifth embodiment. In this flowchart, first, the CD card 10 set on the tray 808 is driven (step S201). Subsequently, a game program is read out from the read only area 113 of the CD card 10 (step S202).

After data related to the game program is further read out (step S203), the controller checks to see if any one of the controller switches 802a, 802b, 802c and 802d; 803a, 803b, 803c, 803d; and joysticks 804a, 804b has been operated (step S204).

When none of the controller switches and the joysticks are operated, the controller waits until one of them is operated, at which time a game program is executed depending on the operated one of them (step S205).

Then, the game program continues to be executed until a command of game end is inputted (step S206). A command about if data on progression of the game should be recorded or not is then inputted (step S207). If the command that requires to record the data on progression of the game is input, data produced by execution of the game program is recorded in the additionally writing area 114 (step S208) to thereby end the game.

As described above, by using the CD card 10 in the game device 180, the game program recorded in the read only area 113 having a large capacity is executed to thereby play the game, and data produced by the playing of the game is written in the additionally writing area 114. Thus, the game device 180 provides high interest and convenience.

### Sixth Embodiment

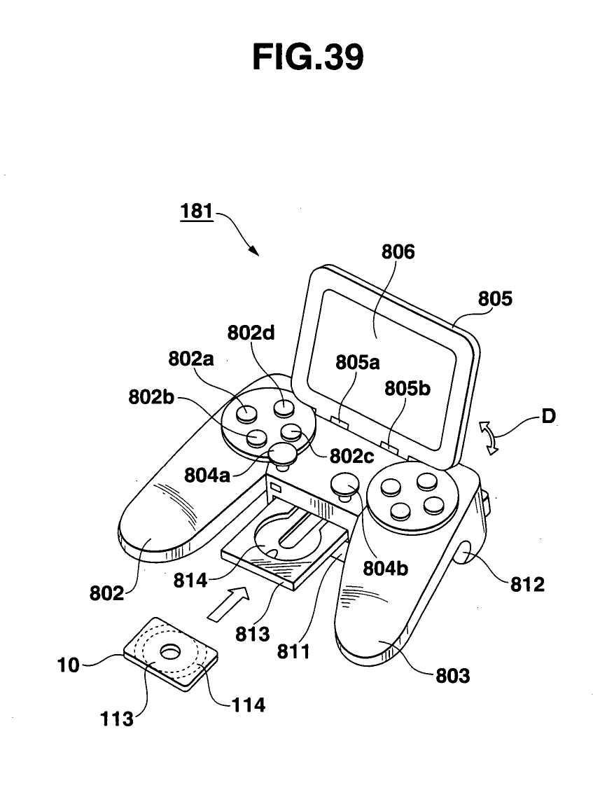

FIG. 39 is a perspective view of a game device 181 in a sixth embodiment of the present invention. As shown in FIG. 39, the game device 181 has substantially the same composition as the game device 180 of the fifth embodiment.

Like the game device 180 (FIG. 36), the game device 181 comprises a pair of grips 802 and 803 each contain a recess 812. The user grips the pair of grips 802 and 803 with hands for manipulating purposes.

The game device 181 comprises a cover 805 with a liquid crystal panel 806 that is rotatable in a direction shown by a double-headed arrow D around a pair of hinges 805a and 805b relative to the body 811.

In the game device 181, a tray 813 is provided so as to move into/out of the housing 811 between the pair of grips 802 and 803. The tray 813 has a recess 814 at its center where the CD card 10 is settable.

When the CD card 10 is set in the recess 814, the tray 813 is moved along with the CD card 10 into the housing 811 by the loading motor (not shown).

The game can be played by operation of an internal circuit (not shown) of the game device 181. The game device 181 provides high interest and convenience by using the CD card 10. The cover 805 provided to the housing 811 is turnable around its lower edge, in the direction shown by the arrow D, to thereby adjust the visibility of the liquid crystal panel 806 appropriately.

In the fifth embodiment, the cover 805 may be removable from the housing 811.

### Seventh Embodiment

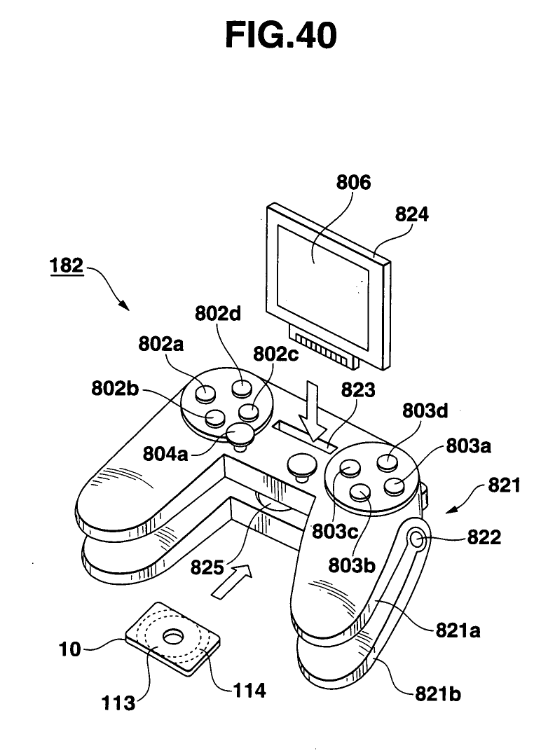

FIG. 40 is a perspective view of a game device 182 in a seventh embodiment of the invention. As shown in FIG. 40,, the game device 182 has substantially the same composition as the game device 180 of the sixth embodiment.

A body 821 of the game device 182 comprises a pair of upper and lower body sections 821a and 821b that are coupled rotatable by a hinge 822.

Disposed on an upper surface of the upper body section 821a are controller switches 802a, 802b, 802c, 802d; 803a, 803b, 803c, 803d and a pair of joysticks 804a, 804b.

The upper body section 821a has a display slot 823 on its center in which a display device 824 with a liquid crystal panel 806 will be fitted and fixed.

A tray 825 is provided between the pair of upper and lower body sections 821a and 821b of the body 821. By setting a CD card 10 in the tray 825, and then depressing the pair of upper and lower body sections 821a and 821b to each other, the CD card 10 is loaded, a game program is started for playing the game.

According to the respective fifth-seventh embodiments, the game devices 180, 181 and 182 each comprise the various controller switches 802a, 802b, 803c, 802d; 803a, 803b, 803c, 803d; and joysticks 804a, 804b to be manipulated by the game player; the drive mechanism; the drive control circuit; liquid crystal panel 806 that displays the contents of a game to be played. The game devices 180, 181 and 182 further comprise the card trays 808, 813 and 825, respectively. Thus, the game player can enjoy a game easily and rapidly anywhere and anytime, for example, outdoors, in an electric train outside his or her household.

A game program and character image data to be used in a game are stored in the read only area 113. Scores produced by operating the various switches of each of the game devices 180, 181, 182, various parameter data such as pet growing data, and game result data are recorded in the additionally writing area 114. Thus, when the game is reopened, data can be accessed instantaneously from the additionally writing area 114 for using purposes as well as the CD card has a large memory capacity compared to the conventional memory cards or portable external memories.

In the conventional game provided by an optical recording medium such as a CD, another recording medium is very often required that records data produced as the game proceeds. For example, when a long time is required to play one game, the situation of game progression needs to be stored as data. An interest of the game is increased often by storing data produced by the user's operation during playing, game scores, etc.

According to the fifth-seventh embodiments, a game program recorded in the read only area 113 can be executed to play a game and data produced by the playing can be recorded in the additionally writing area 114, using the CD card 10. Thus, the game device provides high interest and high convenience. The CD card 10 comprises an optical recording medium, and hence its capacity can increase. Thus, the CD card 10 can adapt to increasing quantities of image data and game programs to increase the interest of the game. Further, the memory capacity of the additionally writing area 114 can increase so as to enjoy the game for a long time.

What is claimed is:

1. A recording medium controlling apparatus for reading/writing data from/to a recording data area as a recording track formed on a non-circular recording medium while rotating the recording medium, said apparatus comprising:
detecting means for detecting a discontinuity in the recording track due to the non-circularity of the recording medium during rotation of the recording medium; and
combining means for combining data present on recording data area portions present before and after the discontinuity in a rotating direction of the recording medium and detected by said detecting means so that these data continue.

2. The non-circular recording medium according to claim 1, wherein the recording medium has a non-circular shape such as a triangle, square, polygon, ellipse for star.

3. The recording medium controlling apparatus according to claim 1, wherein said detecting means comprises optical detecting means for optically detecting the discontinuity in the recording track.

4. The recording medium controlling apparatus according to claim 1, wherein said detecting means comprises light-intercept detecting means for detecting the discontinuity depending on whether or not light illuminating the recording medium during rotation of the recording medium is intercepted or not.

5. A recording medium controlling apparatus for reading recorded data from a recording section formed on a non-circular recording medium while rotating the recording medium, said apparatus comprising:
detecting means for detecting a non-circular data storage area present on the recording medium due to the non-circularity of the recording medium during its and
controlling means for combining data on the recording section portions present before and after the non-circular data storage area detected by said detecting means.

6. A recording medium controlling apparatus for reading recorded data from a recording section formed on a non-circular recording medium while rotating the recording medium, said apparatus comprising:
detecting means for detecting possible effective data-reading areas and ineffective data-reading areas present on the recording medium due to its non-circular shape when data is read form the recording section by rotating the recording medium; and
data combining means, responsive to the data reading being completed, for deleting data present in the ineffective data reading area detected by said detecting means, and for combining the data in the detected effective data-reading areas present directly before and after the ineffective data-reading area, if any.

7. A recording medium controlling method for reading/writing data from/to a recording data area as a recording track formed on a non-circular recording medium while rotating the recording medium, said method comprising the steps of;
detecting a discontinuity in the recording track due to the non-circularity of the recording medium during rotation of the recording medium; and
combining data present on recording data area portions present before and after the discontinuity in a rotating direction of the recording medium and detected in the detecting step so that these data continue.
